(19) United States
(12) Patent Application Publication
(10) Pub. No.: US 2002/0172476 A1
(43) Pub. Date: Nov. 21, 2002

(54) Optical module, optical transmitter and optical receiver

(76) Inventors: Tohru Nagase, Tokyo (JP); Minoru Tajima, Tokyo (JP); Hiroshi Aruga, Tokyo (JP); Hideyuki Oohashi, Tokyo (JP); Masaki Noda, Tokyo (JP); Shinichi Kaneko, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/972,917

(22) Filed: Oct. 10, 2001

(30) Foreign Application Priority Data
May 16, 2001 (JP) 2001-146833

(51) Int. Cl. G02B 6/42

(52) U.S. Cl. 385/92; 385/94

(57) ABSTRACT

An optical signal is output from an optical semiconductor element according to a high frequency signal. The optical semiconductor element is surrounded by a metallic package having a package base, a package cover and a seal ring so as to separate the optical semiconductor element from the outside air. An electromagnetic wave absorptive element is arranged on an inner surface of the metallic package to attenuate the high frequency signal leaking into the cavity of the metallic package, and the electromagnetic wave absorptive element is covered with a seal element so as to hermetically seal the electromagnetic wave absorptive element from the cavity. The seal element allows the high frequency signal to be transmitted through the seal element. The high frequency signal leaking into the cavity is transmitted through the seal element and is converted into heat energy in the electromagnetic wave absorptive element. Therefore, cavity resonance due to the high frequency signal leaking into the cavity can be suppressed. Also, outgas emitted from the electromagnetic wave absorptive element does not leak into the cavity due to the seal element. Therefore, the optical signal receives no adverse influence of the cavity resonance or outgas.

### BACKGROUND OF THE INVENTION

1. Field of the Invention

The present invention relates to an optical module, an optical transmitter and an optical receiver used for an optical communication, and more particularly to an optical module having a package in which an optical semiconductor element receiving or outputting a high frequency signal is arranged, an optical transmitter having the optical module and an optical receiver having the optical module.

2. Description of Related Art

Various types of conventional optical modules have been used in optical communication. In a type of conventional optical module, an electric signal sent from the outside is received in a laser diode to actuate the laser diode, and an optical signal radiated from the laser diode is sent to an optical fiber through a lens. Also, in another type of conventional optical module, a first optical signal (or a carrier wave signal) is received in an electroabsorption element through a first optical fiber, the first optical signal is modulated in the electroabsorption element according to an electric signal of a frequency (ranging from a frequency of a direct current to a high frequency band such as a microwave band or a millimeter wave band), and the modulated optical signal is sent as an second optical signal to a second optical fiber through a lens.

In these types of optical modules, an optical semiconductor element representing the laser diode or the electroabsorption element is surrounded by a conductor wall. That is, the types of optical modules are packaged. In this case, each optical module has a cavity in which an optical semiconductor element such as a laser diode or an electroabsorption element is arranged. Therefore, in cases where a high frequency signal is received in the optical semiconductor element, a part of the high frequency signal leaks into the cavity as electromagnetic waves, the electromagnetic waves are repeatedly reflected on package walls in the cavity, and resonance (hereinafter, called cavity resonance) of the electromagnetic waves occurs.

In cases where a conventional optical module is used for an optical transmitter, an optical receiver or an optical transceiver, a problem has arisen that the performance of the conventional optical module is degraded due to the occurrence of such cavity resonance.

FIG. 30 is a view showing fluctuation of the intensity of an optical signal caused by the cavity resonance of the high frequency signal in the conventional optical module, and FIG. 31 is a view showing a waveform of an optical signal radiated from a laser diode in cases where the cavity resonance occurs in the conventional optical module. As shown in FIG. 30, the frequency response characteristic of the intensity of an optical signal is such that energy loss of the optical signal due to the resonance is high in cases where a high frequency signal having a frequency higher than 10 GHz is received in the optical semiconductor element, and dips equivalent to tens decibels (dB) occur in the intensity of the optical signal. Also, as shown in FIG. 31, jitters in the passage of time and fluctuations of the amplitude of the optical signal occur in output waveforms (called eye pattern) at leading and trailing edges, and eye opening areas of the output waveforms are decreased.

In general, to prevent cavity resonance from occurring in a conventional optical module in which a high frequency signal such as a microwave signal or a millimeter wave signal is received or output, a package of the conventional optical module is made small or is formed in a complicated shape (a first method). In this case, a minimum resonance frequency required to generate cavity resonance in the optical module is heightened to a frequency higher than that of the high frequency signal such as a microwave or a millimeter wave. Therefore, no cavity resonance occurs in the optical module, and the performance of the optical module is not degraded.

Also, in a second method, all or part of the package of the conventional optical module is made of a non-metallic material. In this case, the reflection of the electromagnetic waves on surfaces of the package is reduced.

Also, in a third method, an electromagnetic wave absorptive element is arranged in a package of the conventional optical module. In this case, electromagnetic waves generated from the high frequency signal in the cavity of the conventional optical module are transformed into heat energy and attenuated by the electromagnetic wave absorptive element. As a result, the electromagnetic wave absorptive element can prevent the cavity resonance from occurring in the conventional optical module.

However, since the conventional optical module has the configuration described above, there are following problems in the conventional optical module, an optical transmitter having the conventional optical module, an optical receiver having the conventional optical module and an optical transceiver having the conventional optical module.

In case of the first method, because a constant temperature element (for example, a Peltier element) having a large capacity, a driver circuit actuating the optical semiconductor element and an optical interface connecting an output side of the optical semiconductor element and the outside are arranged, it is difficult to produce a small-sized package or a complicated shape of a package at a cheap cost in the conventional optical module for the purpose of reducing a size of the cavity in the conventional optical module. Therefore, a minimum resonance frequency required to generate the cavity resonance in the conventional optical module can not be sufficiently heightened, and the optical signal is adversely influenced by the cavity resonance of electromagnetic waves derived from the high frequency signal. As a result, a problem has arisen that the performance of the optical module is degraded so as to produce fluctuation in the intensity of the optical signal.

Also, in case of the second method, because all or part of the package of the conventional optical module is made of a non-metallic material, the influence of external noise is exerted on the optical semiconductor element. In this case, because it is required of the conventional optical module to be operated at a stable performance in a super-broadband frequency range (ranging from a frequency equivalent to a direct current to a frequency of a millimeter wave band), a problem has arisen that the performance of the conventional optical module is degraded so as to produce fluctuation in the intensity of the optical signal.

Also, in case of the third method, gas (hereinafter, called outgas) is emitted from the electromagnetic wave absorptive element, and unnecessary particles or material are scattered from the electromagnetic wave absorptive element to the cavity of the package. In this case, the outgas chemically reacts with the semiconductor composing the optical semiconductor element to give an adverse influence on an intensity of the optical signal radiated from the optical semiconductor element or to shorten a life time of the optical semiconductor element. Also, the outgas is attached as solid matter to optical elements such as the optical semiconductor element and a lens. Also, the unnecessary particles or material are attached to the optical elements. Therefore, optical performances of the optical elements are degraded. As a result, a problem has arisen that the performance of the optical module is degraded so as to produce fluctuation in the intensity of the optical signal.

Also, a package of a high-frequency integrated circuit has been disclosed in Published Unexamined Japanese Patent Application 2000-138495. In this patent application, the influence of outgas emitted from an electromagnetic wave absorptive element is considered. In detail, a package is arranged to separate a high frequency circuit of the inside from the outside, and an electromagnetic wave absorptive element is attached to an outside wall of the package. However, in this package of the high-frequency integrated circuit, a package structure for arranging both a driver circuit actuating an optical semiconductor element and an optical interface unit in the package is not disclosed. Also, in cases where a constant temperature element having a large capacity is arranged in the package, a size of the cavity in the package is enlarged so as to generate cavity resonance at a low resonance frequency. However, in this patent application, a problem based on the enlarged cavity size is not considered.

### SUMMARY OF THE INVENTION

A main object of the present invention is to provide, with due consideration to the drawbacks of the conventional optical module, an optical module, an optical transmitter and an optical receiver in which cavity resonance is suppressed so as not to degrade the performance of an optical semiconductor element while preventing outgas from leaking into a cavity.

Also, a subordinate object of the present invention is to provide an optical module, an optical transmitter and an optical receiver in which cavity resonance is suppressed in a package structure having a circuit electrically connected with an optical semiconductor element or a constant temperature element in a package while preventing outgas from leaking into a cavity.

The main object is achieved by the provision of an optical module, comprising an optical semiconductor element for receiving or outputting a high frequency signal, a package having a cavity in which the optical semiconductor element is placed, an electromagnetic wave absorptive element, arranged on an inner surface of the package, for attenuating electromagnetic waves which are generated in the cavity of the package by the high frequency signal, and a seal element for covering the electromagnetic wave absorptive element and hermetically sealing the electromagnetic wave absorptive element from the cavity of the package, the seal element being made of material which allows the electromagnetic waves to penetrate therethrough.

In the above configuration, even though electromagnetic waves are generated from the high frequency signal in the cavity of the package, the electromagnetic waves are transmitted through the seal element and are converted into heat energy in the electromagnetic wave absorptive element. Also, even though outgas is emitted from the electromagnetic wave absorptive element, because the electromagnetic wave absorptive element is hermetically sealed by the seal element from the cavity of the package, the outgas does not leak into the cavity of the package.

Accordingly, the outgas can be prevented from leaking into the cavity of the package, and the cavity resonance due to the electromagnetic waves can be suppressed so as not to degrade the performance of the optical semiconductor element.

It is preferred that the package has a package box and a package cover which are joined to each other, and wherein the package cover is formed with the inner surface on which the electromagnetic wave absorptive element is arranged.

Therefore, the cavity resonance can be reliably suppressed.

It is also preferred that the package cover includes a metal layer or a metal substrate. Therefore, suppression of external noise is ensured.

It is also preferred that the package has a concavity in which the electromagnetic wave absorptive element is arranged, and wherein the concavity is covered with the seal element to hermetically seal the electromagnetic wave absorptive element from the cavity of the package.

Therefore, the electromagnetic wave absorptive element can be reliably sealed by the seal element from the cavity of the package, and the leaking of the outgas into the cavity of the package can be reliably prevented.

It is also preferred that the package cover has a dielectric substrate, a metal layer covering an outer surface of the dielectric substrate, and a metal ring surrounding the dielectric substrate and joined to the package box.

Therefore, suppression of external noise is ensured.

It is also preferred that the package has a package box, which has a bottom wall portion and a side wall portion, and a package cover which is joined to the side wall portion of the package box, and wherein the side wall portion of the package box is formed with the inner surface on which the electromagnetic wave absorptive element is arranged.

Therefore, the cavity resonance can be reliably suppressed.

It is also preferred that the package has a package box, which has a bottom wall portion and a side wall portion, and a package cover which is joined to the side wall portion of the package box, and wherein the bottom wall portion of the package box is formed with the inner surface on which the electromagnetic wave absorptive element is arranged.

Therefore, the cavity resonance can be reliably suppressed.

It is also preferred that the seal element is formed of a coating layer with which all surfaces of the electromagnetic wave absorptive element are covered, and a combination of the electromagnetic wave absorptive element and the coating layer is attached to the inner surface of the package.

Therefore, the leaking of the outgas into the cavity of the package can be reliably prevented by using a simple sealing structure, and the cavity resonance can be reliably suppressed.

It is also preferred that the coating layer is formed of a dielectric material.

Therefore, the electromagnetic waves can be reliably transmitted through the coating layer.

It is also preferred that the electromagnetic wave absorptive element includes a conductive or magnetic material and an organic material.

Therefore, the electromagnetic waves can be reliably converted into heat energy.

It is also preferred that the package has a wall portion which is made of metal, and wherein the wall portion is formed with the inner surface on which the electromagnetic wave absorptive element is arranged.

Therefore, suppression of external noise is ensured.

It is also preferred that the package has a wall portion of which an outer surface is covered with a metal layer, and wherein the wall portion is formed with the inner surface on which the electromagnetic wave absorptive element is arranged.

Therefore, suppression of external noise is ensured.

It is also preferred that the seal element is made of dielectric material.

Therefore, the electromagnetic waves can be reliably transmitted through the seal element.

It is also preferred that the optical semiconductor element is formed of a laser diode.

Therefore, the high frequency signal is received in the laser diode, and an optical signal is output from the laser diode.

It is also preferred that the optical semiconductor element is formed of an electroabsorption element.

Therefore, the high frequency signal is received in the electroabsorption element, a carrier signal is transformed into an optical signal according to the high frequency signal in the electroabsorption element.

It is also preferred that the optical semiconductor element is formed of a photo diode.

Therefore, an optical signal is transformed into the high frequency signal in the photo diode, and the high frequency signal is output from the photo diode.

The main object is also achieved by the provision of an optical module, comprising an optical semiconductor element for receiving or outputting a high frequency signal, a package having both a cavity, in which the optical semiconductor element is placed, and a wall portion which allows electromagnetic waves to penetrate therethrough, an electromagnetic wave absorptive element, arranged on an outer surface of the wall portion of the package, for attenuating electromagnetic waves which are generated in the cavity of the package by the high frequency signal, and a metal layer for covering an outer surface of the electromagnetic wave absorptive element.

In the above configuration, even though electromagnetic waves are generated from the high frequency signal in the cavity of the package, the electromagnetic waves are transmitted through the wall portion of the package and are converted into heat energy in the electromagnetic wave absorptive element. Also, even though outgas is emitted from the electromagnetic wave absorptive element, because the electromagnetic wave absorptive element is hermetically sealed by the wall portion of the package from the cavity of the package, the outgas does not leak into the cavity of the package.

Accordingly, the leaking of the outgas into the cavity of the package can be prevented, and the cavity resonance due to the electromagnetic waves can be suppressed so as not to degrade the performance of the optical semiconductor element.

It is preferred that the electromagnetic wave absorptive element includes a conductive or magnetic material and an organic material.

Therefore, the electromagnetic waves can be reliably converted into heat energy.

It is also preferred that the optical semiconductor element is formed of a laser diode.

Therefore, the high frequency signal is received in the laser diode, and an optical signal is output from the laser diode.

It is also preferred that the optical semiconductor element is formed of an electroabsorption element.

Therefore, the high frequency signal is received in the electroabsorption element, a carrier signal is transformed into an optical signal according to the high frequency signal in the electroabsorption element.

It is also preferred that the optical semiconductor element is formed of a photo diode.

Therefore, an optical signal is transformed into the high frequency signal in the photo diode, and the high frequency signal is output from the photo diode.

It is also preferred that the package has a package box and a package cover which are joined to each other, the package cover has both a dielectric substrate equivalent to the wall portion and a metal ring which surrounds the dielectric substrate and is joined to the package box.

Therefore, the electromagnetic waves can be reliably transmitted through the dielectric substrate, and the cavity resonance can be reliably suppressed.

The main and subordinate objects are achieved by the provision of an optical module, comprising an optical semiconductor element for receiving or outputting a high frequency signal, a circuit electrically connected to the optical semiconductor element, a first package having a cavity in which the optical semiconductor element is placed, a second package having a cavity in which the circuit and the first package are placed, an electromagnetic wave absorptive element, arranged on an inner surface of the second package, for attenuating electromagnetic waves which are generated in the cavity of the second package by the high frequency signal, and a seal element for covering the electromagnetic wave absorptive element and hermetically sealing the electromagnetic wave absorptive element from the cavity of the second package, the seal element being made of material which allows the high frequency signal to penetrate therethrough.

In the above configuration, even though electromagnetic waves are generated from the high frequency signal in the cavity of the second package, the electromagnetic waves are transmitted through the seal element and are converted into heat energy in the electromagnetic wave absorptive element. Also, because the electromagnetic wave absorptive element is not arranged in the cavity of the first package, there is no probability that the optical semiconductor element is exposed to outgas emitted from the electromagnetic wave absorptive element.

Accordingly, an adverse influence of the outgas on the optical semiconductor element can be prevented. Also, because the circuit electrically connected to the optical semiconductor element is arranged in the cavity of the second package, a size of the cavity of the first package is reduced, and the cavity resonance due to the electromagnetic waves in the cavity of the first package can be suppressed so as not to degrade the performance of the optical semiconductor element.

It is also preferred that the optical module further comprises a constant temperature element, which is placed in the cavity of the second package and has the first package placed thereon, for keeping a temperature of the optical semiconductor element at a constant value through the first package.

Because the constant temperature element having a large capacity is not arranged in the cavity of the first package but is arranged in the cavity of the second package, a size of the cavity of the first package can be reduced. Therefore, the cavity resonance in the cavity of the first package can be suppressed.

The main and subordinate objects are achieved by the provision of an optical module, comprising an optical semiconductor element for receiving or outputting a high frequency signal, a circuit electrically connected to the optical semiconductor element, a first package having a cavity in which the optical semiconductor element is placed, and a second package having a cavity in which the circuit and the first package are placed.

In the above configuration, because the circuit electrically connected to the optical semiconductor element is arranged in the cavity of the second package, a size of the cavity of the first package is reduced. Therefore, the cavity resonance due to the electromagnetic waves in the cavity of the first package can be suppressed so as not to degrade the performance of the optical semiconductor element.

Also, no electromagnetic wave absorptive element is arranged in the optical module. Therefore, an adverse influence of outgas emitted from the electromagnetic wave absorptive element on the optical semiconductor element can be prevented.

It is preferred that the second package has a package box and a package cover which are joined to each other, and wherein the package cover of the second package has a protrusive portion which faces the circuit.

Therefore, a size of the cavity of the second package is reduced by the protrusive portion, and the cavity resonance in the cavity of the second package can be suppressed.

It is also preferred that the optical module further comprises a constant temperature element, which is placed in the cavity of the second package and has the first package placed thereon, for keeping a temperature of the optical semiconductor element at a constant value through the first package.

Because the constant temperature element having a large capacity is not arranged in the cavity of the first package but is arranged in the cavity of the second package, a size of the cavity of the first package can be reduced. Therefore, the cavity resonance in the cavity of the first package can be suppressed.

The main object is achieved by the provision of an optical transmitter, comprising an interface unit for receiving electric signals and outputting a high frequency signal; and an optical module for receiving the high frequency signal from the interface unit and outputting an optical signal. The optical module comprises an optical semiconductor element for receiving the high frequency signal and producing the optical signal, a package having a cavity in which the optical element is placed, an electromagnetic wave absorptive element, arranged on an inner surface of the package, for attenuating electromagnetic waves which are generated in the cavity of the package by the high frequency signal, and a seal element for covering the electromagnetic wave absorptive element and hermetically sealing the electromagnetic wave absorptive element from the cavity of the package, the seal element being made of material which allows the high frequency signal to penetrate therethrough.

Therefore, the optical transmitter using the optical module can be obtained.

It is preferred that the interface unit comprises a multiplexer for multiplexing the electric signals to produce the high frequency signal.

Therefore, the high frequency signal can be produced in the multiplexer.

It is also preferred that the optical semiconductor element of the optical module is formed of a laser diode, and the interface unit further comprises a driver circuit for amplifying the high frequency signal produced by the multiplexer to output an amplified high frequency signal to the laser diode.

Therefore, an optical signal can be output from the laser diode according to the amplified high frequency signal.

It is also preferred that the optical transmitter further comprises a second optical module for receiving an electric signal and outputting a second signal. The optical module is a first optical module having the optical semiconductor element formed of an electroabsorption element. The first optical module comprises a driver circuit for amplifying the high frequency signal produced by the multiplexer and outputting an amplified high frequency signal to the electroabsorption element to make the electroabsorption element convert the second optical signal output from the second optical module into the optical signal according to the amplified high frequency signal and output the optical signal.

Therefore, the second optical signal output from the second optical module can be converted into the optical signal in the electroabsorption element according to the amplified high frequency signal, and the optical signal can be output from the electroabsorption element.

It is also preferred that the driver circuit is placed in the cavity of the package.

The main object is achieved by the provision of an optical receiver, comprising an optical module for receiving an optical signal and outputting a high frequency signal, and an interface unit for receiving the high frequency signal from the optical module and outputting electric signals. The optical module comprises a photo diode for receiving the optical signal and producing the high frequency signal, a package having a cavity in which the photo diode is placed, an electromagnetic wave absorptive element, placed on an inner surface of the package, for attenuating electromagnetic waves which are generated in the cavity of the package by the high frequency signal, and a seal element for covering the electromagnetic wave absorptive element and hermetically sealing the electromagnetic wave absorptive element from the cavity of the package, the seal element being made of material which allows the high frequency signal to penetrate therethrough.

Therefore, the optical transmitter using the optical module can be obtained.

It is preferred that the interface unit comprises a demultiplexer for demultiplexing the high frequency signal produced by the photo diode to produce electric signals.

Therefore, electric signals can be obtained.

It is also preferred that the interface unit further comprises an amplifier for amplifying the high frequency signal and outputting an amplified high frequency signal to the demultiplexer to make the demultiplexer produce the electric signals from the amplified high frequency signal.

Therefore, electric signals can be reliably obtained.

### BRIEF DESCRIPTION OF THE DRAWINGS

FIG. 1A is a perspective top view of an optical module according to a first embodiment of the present invention;

FIG. 1B is a vertical sectional view taken substantially along line A-A of FIG. 1A;

FIG. 2A is a vertical sectional view taken substantially along line B-B of FIG. 1A;

FIG. 2B is a plan view of a package cover of the optical module shown in FIG. 1A, FIG. 1B and FIG. 2A;

FIG. 3 is a view of a frequency response characteristic of the optical signal according to the first embodiment;

FIG. 4 is a view of an output power of the optical signal according to the first embodiment;

FIG. 5 is a perspective top view of an optical module according to a modification of the first embodiment of the present invention;

FIG. 6A is a vertical sectional view taken substantially along line A-A of FIG. 5;

FIG. 6B is a vertical sectional view taken substantially along line B-B of FIG. 5;

FIG. 6C is a plan view of a package cover of the optical module shown in FIG. 5, FIG. 6A and FIG. 6B;

FIG. 7 is a perspective top view of an optical module according to a second embodiment of the present invention;

FIG. 8 is a vertical sectional view taken substantially along line A-A of FIG. 7;

FIG. 9 is a perspective top view of an optical module according to a third embodiment of the present invention;

FIG. 10 is a vertical sectional view taken substantially along line A-A of FIG. 9;

FIG. 11 is a perspective top view of an optical module according to a fourth embodiment of the present invention;

FIG. 12 is a vertical sectional view taken substantially along line A-A of FIG. 11;

FIG. 13 is a vertical sectional view taken substantially along line B-B of FIG. 11;

FIG. 14 is a plan view of a package cover, in which an electromagnetic wave absorptive element is arranged, according to a fifth embodiment of the present invention;

FIG. 15 is a vertical sectional view taken substantially along line C-C of FIG. 14;

FIG. 16 is a vertical sectional view of an electromagnetic wave absorptive element hermetically coated according to a sixth embodiment of the present invention;

FIG. 17 is a vertical sectional view taken substantially along line A-A of FIG. 1A according to the sixth embodiment to show a hermetically-coated electromagnetic wave absorptive element arranged on a package cover of an optical module;

FIG. 18 is a vertical sectional view taken substantially along line B-B of FIG. 1A according to the sixth embodiment to show the hermetically-coated electromagnetic wave absorptive element arranged on a package cover of an optical module;

FIG. 19 is a vertical sectional view of a package cover, in which the electromagnetic wave absorptive element is arranged, according to a seventh embodiment of the present invention;

FIG. 20 is a perspective top view of an optical module according to an eight embodiment of the present invention;

FIG. 21 is a vertical sectional view taken substantially along line A-A of FIG. 20 according to the eighth embodiment;

FIG. 22 is a vertical sectional view taken substantially along line B-B of FIG. 20 according to the eighth embodiment;

FIG. 23 is a vertical sectional view taken substantially along line A-A of FIG. 20 according to a ninth embodiment of the present invention;

FIG. 24 is a vertical sectional view taken substantially along line B-B of FIG. 20 according to the ninth embodiment;

FIG. 25 is a vertical sectional view taken substantially along line A-A of FIG. 20 according to a tenth embodiment of the present invention;

FIG. 26 is a vertical sectional view taken substantially along line B-B of FIG. 20 according to the tenth embodiment;

FIG. 27 is a block diagram of an optical transmitter according to an eleventh embodiment of the present invention;

FIG. 28 is a block diagram of an optical receiver according to the eleventh embodiment;

FIG. 29 is a block diagram of an optical transmitter according to a twelfth embodiment of the present invention;

FIG. 30 is a view showing fluctuation of an intensity of an optical signal caused by cavity resonance of a high frequency signal in a conventional optical module; and

FIG. 31 is a view showing a waveform of an optical signal radiated from a laser diode in cases where cavity resonance occurs in a conventional optical module.

### DETAILED DESCRIPTION OF THE PREFERRED EMBODIMENTS

Embodiments of the present invention will now be described with reference to the accompanying drawings.

Embodiment 1

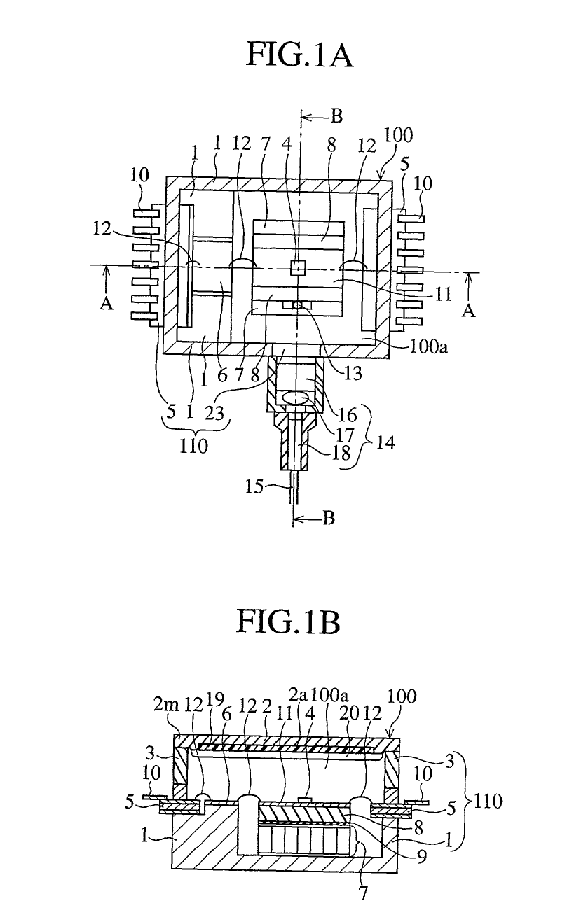

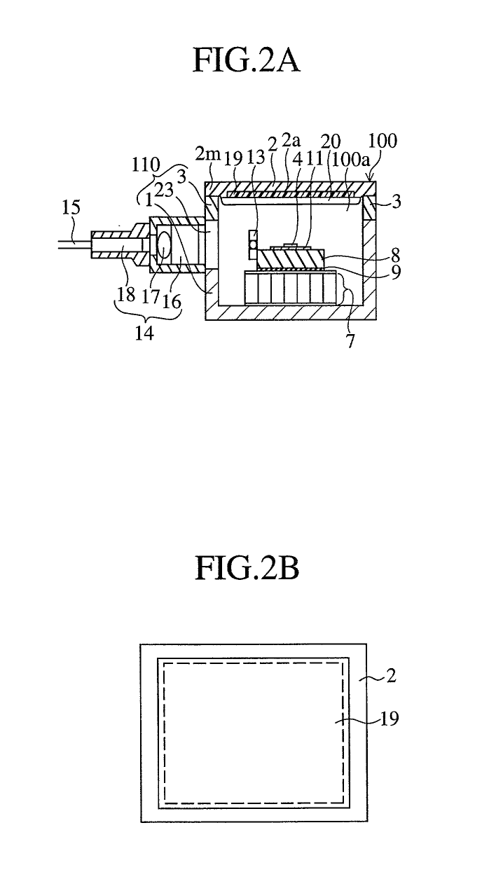

FIG. 1A is a perspective top view of an optical module according to a first embodiment of the present invention, and FIG. 1B is a vertical sectional view taken substantially along line A-A of FIG. 1A. Also, FIG. 2B is a vertical sectional view taken substantially along line B-B of FIG. 1A, and FIG. 2B is a plan view of a package cover of the optical module shown in FIG. 1A, FIG. 1B and FIG. 2A.

In FIG. 1A, FIG. 1B, FIG. 2A and FIG. 2B, 100 indicates a package of an optical module according to a first embodiment. 1 indicates a package base, 2 indicates a package cover arranged above the package base 1, and 3 indicates a seal ring connecting the package base 1 and the package cover 2. A metal substrate 2m is included in the package cover 2, and an electromagnetic wave absorptive element described later in detail is hermetically sealed in a concave area (or a concavity) 2a of the package cover 2.

4 indicates an optical semiconductor element (for example, a laser diode) for receiving an electric signal including a high frequency signal from the outside and outputting an optical signal in response to the electric signal. 5 indicates a feed through unit through which the electric signal including the high frequency signal is lead to the optical semiconductor element 4. The feed through unit 5 is arranged between the package base 1 and the seal ring 3 on both sides (the left side and the right side in FIG. 1A) of the package 100. Each feed through unit 5 is, for example, brazed to the package base 1 and the seal ring 3. 6 indicates a driver integrated circuit (IC) for reshaping a waveform of the electric signal including the high frequency signal and amplifying the electric signal which passes through the feed through unit 5 placed on the left side. The driver IC 6 is placed on the package base 1. 23 indicates an optical window arranged between the seal ring 3 and the package base 1. The optical signal radiated from the optical semiconductor element 4 is transmitted through the optical window 23.

In this embodiment, a package box 110 is composed of the package base 1, the seal ring 3, the optical window 23 and the feed through units 5. The package box 110 is jointed to the package cover 2, and the package 100 of the optical module is composed of the package box 110 and the package cover 2 jointed to each other. Also, a cavity 100a is formed in the package 100. The cavity 100a of the package 100 is separated from the outside by the package box 110 and the package cover 2. In other words, the cavity 100a of the package 100 is hermetically sealed from the outside. Also, the package base 1 and the seal ring 3 are made of metal, and the package cover 2 includes the metal substrate 2m made of a metallic plate. Therefore, the optical semiconductor element 4 and the driver IC 6 are almost completely surrounded by metal. Also, a bottom wall of the package box 110 is formed by a bottom portion of the package base 1, and side walls of the package box 110 are formed by side portions of the package base 1, the feed through units 5, the metal ring 3 and the optical window 23. A ceiling wall of the package 100 is formed by the package cover 2.

Also, 7 indicates a constant temperature element (for example, a Peltier element) for maintaining a temperature of the optical semiconductor element 4, and the constant temperature element 7 is arranged on the package base 1 in the lowest level of the package 100. 8 indicates a metal carrier (or a sub-carrier) for adjusting a height of a lens described later. 9 indicates an insulator for electrically insulating the constant temperature element 7 from the metal carrier 8, and the insulator 9 is arranged between the constant temperature element 7 and the metal carrier 8. 10 indicates a group of lead terminals attached to the feed through units 5 on the outsides of the both sides of the package 100. The electric signal including the high frequency signal is received at one lead terminal 10 attached to the feed through unit 5 on the left side. 11 indicates a substrate (or a chip carrier) arranged on the metal carrier 8. The optical semiconductor element 4 is arranged on the substrate 11. The substrate 11 functions as a connecting line of the electric signal to send the electric signal to the optical semiconductor element 4.

12 indicates each of connecting wires. One connecting wire 12 connects the feed through unit 5 placed on the left side and the driver IC 6, another connecting wire 12 connects the driver IC 6 and the substrate 11, and the other connecting wire 12 connects the feed through unit 5 placed on the right side and the substrate 11. The electric signal including the high frequency signal is sent to the optical semiconductor element 4 through the connecting wire 12 and the substrate 11, and an intensity (or a level) of the optical signal output from the optical semiconductor element 4 is controlled.

13 indicates a first lens for converging the optical signal output from the optical semiconductor element 4. The first lens 13 is attached to the metal carrier 8 through a lens holder (not shown). A positional relationship between the first lens 13 and the optical semiconductor element 4 is adjusted when the first lens 13 is attached to the metal carrier 8. 14 indicates an optical interface unit for leading the optical signal converged by the first lens 13 to the outside of the package 100. 15 indicates an optical fiber for receiving the optical signal output from the optical semiconductor element 4 through the optical window 23 and the optical interface unit 14.

In the optical interface unit 14, 16 indicates an optical isolator for leading the optical signal converged by the first lens 13 to the optical fiber 15 almost without attenuation and intercepting a laser beam returned from the optical fiber 15. 17 indicates a second lens for converging the optical signal transmitting through the optical isolator 16 on an end surface of the optical fiber 15. 18 indicates a ferrule connecting the optical fiber 15 and the package 100 of the optical module.

2a indicates the concave area facing an inner surface of the package cover 2. The concave area 2a is almost placed on an inner surface of the whole metal substrate 2m of the package cover 2, and the concave area 2a is opened on the side of the cavity 100a of the package 100. 19 indicates an electromagnetic wave absorptive element placed on the inner surface of the package cover 2. The electromagnetic wave absorptive element 19 is formed in a thin plate shape and is arranged in the concave area 2a of the package cover 2. Electromagnetic waves generated from a part of the high frequency signal are radiated into the cavity 100a and are attenuated in the electromagnetic wave absorptive element 19. 20 indicates a seal element for hermetically sealing the electromagnetic wave absorptive element 19 from the cavity 100a of the package 100. The seal element 20 is made of a material having a high transmittance for the electromagnetic waves and does not emit outgas even though the electromagnetic waves are received. That is, the electromagnetic wave absorptive element 19 is hermetically arranged between the package cover 2 and the seal element 20, and the seal element 20 is arranged on the electromagnetic wave absorptive element 19 so as to directly face the cavity 100a of the package 100. The electromagnetic wave absorptive element 19 is formed by mixing ferrite, carbon, amagnetic material or a conductive fiber material with base material (or organic binder) such as synthetic rubber, fiber reinforced plastics or polyethylene foam. However, it is applicable that the electromagnetic wave absorptive element 19 be formed of conductive resistive films. Also, the seal element 20 is formed of a ceramic, aluminum oxide or silicon.

Next, an operation of the optical module will be described below.

An electric signal (hereinafter, called a high frequency signal) including a high frequency signal is sent from a multiplexing IC (not shown) to one lead terminal 10 placed on the left side of the optical module. This high frequency signal is received in the driver IC 6 through the feed through unit 5 and the connecting wire 12. Thereafter, in the driver IC 6, a waveform of the high frequency signal degraded in the transmission is reshaped, or an intensity of the high frequency signal is adjusted to a level required by the optical semiconductor element 4. Thereafter, the high frequency signal is received in the optical semiconductor element 4, and an optical signal modulated according to the high frequency signal is output from the optical semiconductor element 4. Thereafter, the optical signal is lead to the optical fiber 15 through the optical interface unit 14. Here, the lead terminals 10, the feed through unit 5 and the connecting wire 12 connected with each other on the right side of the optical module are used as monitoring elements.

Here, when the high frequency signal is sent from the lead terminal 10 to the optical semiconductor element 4, a part of the high frequency signal is radiated into the cavity 100a of the package 100 as electromagnetic waves at specific positions at which an impedance of the feed through unit 5 or the connecting wire 12 suddenly changes. The electromagnetic waves are reflected on metallic inner walls of both the package base 1 and the seal ring 3 of the package 100. In contrast, because the seal element 20 is arranged on the ceiling part of the package 100, the electromagnetic waves are incident on the seal element 20, a part of the electromagnetic waves corresponding to a prescribed ratio to the electromagnetic waves incident on the seal element 20 is transmitted through the seal element 20, and the part of the electromagnetic waves are absorbed in the electromagnetic wave absorptive element 19 by transforming the part of the electromagnetic waves into heat energy. That is, the part of the electromagnetic waves corresponding to a prescribed ratio to the electromagnetic waves incident on the seal element 20 does not reflect on the seal element 20 but is attenuated. Therefore, the occurrence of cavity resonance due to the electromagnetic waves generated from the high frequency signal is suppressed, and the performance of the-optical semiconductor element 4 of the optical module can be improved so as to give no adverse influence of the cavity resonance on the optical signal.

Also, in the first embodiment, the electromagnetic wave absorptive element is hermetically arranged in the concave area 2a of the package cover 2 and is sealed from the cavity 100a by the seal element 20. Therefore, even though outgas is emitted from the electromagnetic wave absorptive element 19, the seal element 20 keeps the outgas in the concave area 2a of the package cover 2. Therefore, no outgas leaks into the cavity 100a of the package 100. Accordingly, the performance of the optical semiconductor element 4 or the first lens 13 can be prevented from deteriorating due to the outgas.

Also, in the first embodiment, because the optical semiconductor element 4 is arranged in the cavity 100a surrounded by the metallic package base 1, the metallic package cover 2 and the metallic seal ring 3, the optical semiconductor element 4 is mechanically and electro-magnetically shielded from noise generated in the outside of the package 100. Accordingly, the performance of the optical module can be further improved so as to avoid any influence of the noise on the optical signal.

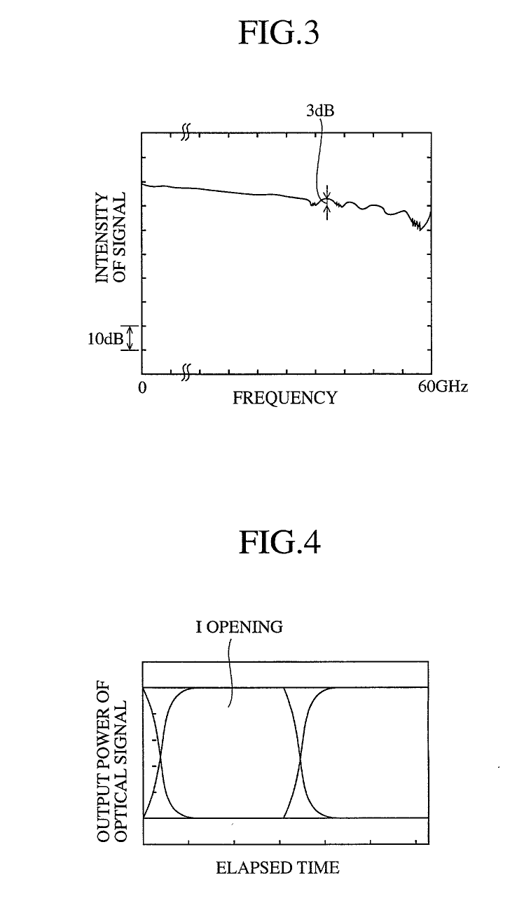

FIG. 3 is a view of a frequency response characteristic of the optical signal according to the first embodiment, and FIG. 4 is a view of an output power of the optical signal according to the first embodiment. As shown in FIG. 3, because the cavity resonance is suppressed in the first embodiment, energy loss in the optical signal is decreased in a high frequency range from 0 to 60 GHz. Also, as shown in FIG. 4, jitters in the passage of time and fluctuations of the amplitude of the optical signal are decreased at leading and trailing edges, and eye opening areas of the output waveforms are increased.

In the first embodiment, a laser diode is used as the optical semiconductor element 4 to convert the high frequency signal into the optical signal. However, the first embodiment is not limited to the laser diode. Also, the first embodiment is not limited to the optical semiconductor element 4 in which the high frequency signal is converted into the optical signal. For example, it is applicable that an electroabsorption element be used as the optical semiconductor element 4 to convert a first optical signal into a second optical signal according to a high frequency signal.

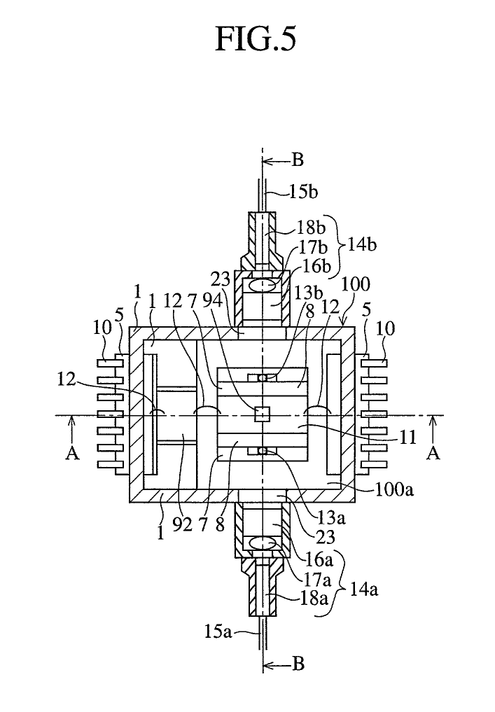

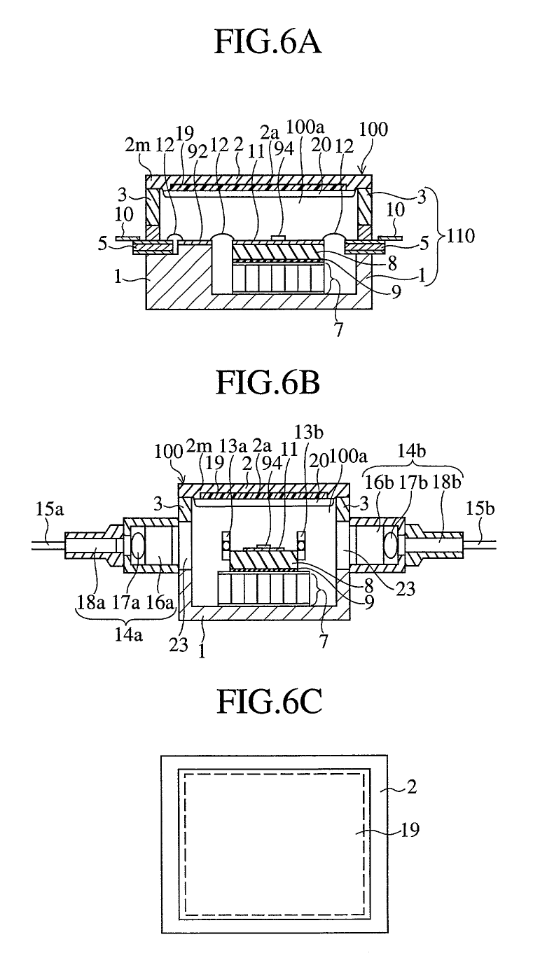

FIG. 5 is a perspective top view of an optical module according to a modification of the first embodiment of the present invention, FIG. 6A is a vertical sectional view taken substantially along line A-A of FIG. 5, FIG. 6B is a vertical sectional view taken substantially along line B-B of FIG. 5, and FIG. 6C is a plan view of a package cover of the optical module shown in FIG. 5, FIG. 6A and FIG. 6B.

In FIG. 5, FIG. 6A and FIG. 6B and FIG. 6C, 92 indicates an electroabsorption (EA) driver. 94 indicates an electroabsorption (EA) element. In case of an optical module having the EA element 94, equivalently to the first lens 13 and the optical interface unit 14 of the optical module shown in FIG. 1A, a first lens 13a and an optical interface unit 14a are arranged on a first side (a lower side in FIG. 5) of the optical module having the EA element 94, and another first lens 13b and another optical interface unit 14b having the same configuration as those of the first lens 13a and the optical interface unit 14a are arranged on a second side (an upper side in FIG. 5) opposite to the first side.

When an optical signal sent from another optical module through the first lens 13a and the optical interface unit 14a is received in the EA element 94, the optical signal is modulated in the EA element 94 according to a high frequency signal transmitting through the EA driver 92, and the modulated optical signal is output from the EA element 94.

Accordingly, an optical signal modulated according to the high frequency signal can be output to the optical interface unit 14b through the first lens 13b.

Also, in the first embodiment, it is applicable that a photo diode be used as the optical semiconductor element 4 to convert an optical signal into an electric signal. In this case, a pre-amplifier is used in place of the driver IC 6 to be electrically connected with the photo diode, and the electric signal produced in the photo diode is amplified.

Also, in following embodiments, it is applicable that the EA element 94 or the photo diode be used as the optical semiconductor element 4 in modifications of the embodiments.

Embodiment 2

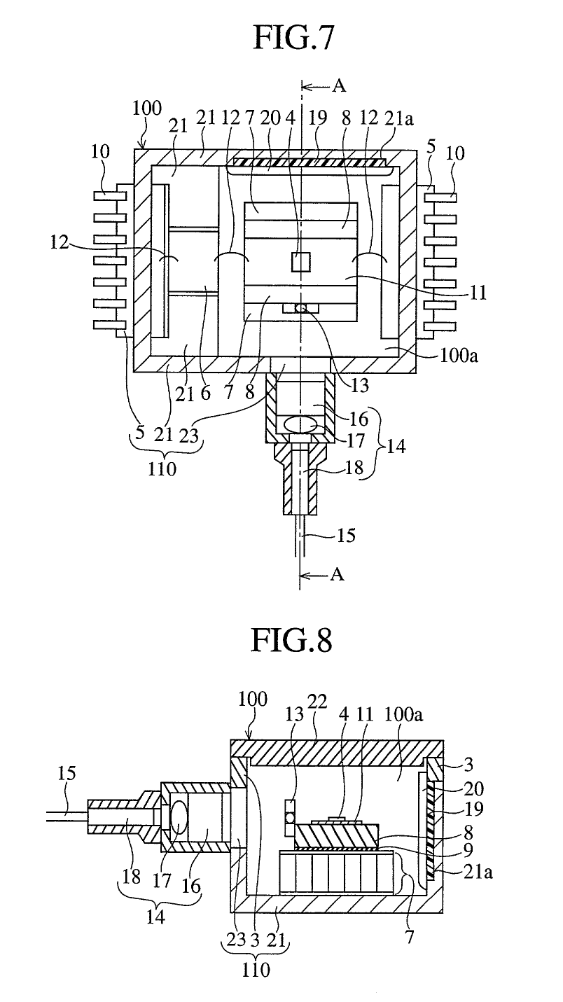

FIG. 7 is a perspective top view of an optical module according to a second embodiment of the present invention, and FIG. 8 is a vertical sectional view taken substantially along line A-A of FIG. 7.

The constituent elements, which are the same as those shown in FIG. 1A, FIG. 1B and FIG. 2A, are indicated by the same reference numerals as those of the constituent elements shown in FIG. 1A, FIG. 1B and FIG. 2A, and additional description of those constituent elements is omitted in this embodiment. Also, additional description of those constituent elements is omitted in following embodiments.

In the first embodiment, the electromagnetic wave absorptive element 19 is arranged in the concave area 2a of the package cover 2 placed on the upper surface of the package 100 of the optical module. In contrast, in a second embodiment, the electromagnetic wave absorptive element 19 is arranged in a concave area which faces an inner side surface of a package base placed on the rear side of the optical module.

In FIG. 7 and FIG. 8, 21 indicates a metallic package base which forms a bottom wall and side walls of the package 100 of the optical module to shield the optical semiconductor element 4 from external noise. The electromagnetic wave absorptive element 19 is arranged in a concave area (or a concavity) 21a which faces an inner side surface of the package base 21 placed on the rear side of the optical module. 22 indicates a metallic package cover arranged on the package base 21 through the seal ring 3. The electromagnetic wave absorptive element 19 is arranged between the package base 21 and the seal element 20 and is hermetically sealed from the cavity 100a of the package 100 in the same manner as in the first embodiment. The seal element 20 faces the cavity 100a of the package 100.

Therefore, the cavity 100a of the package 100 is separated from the outside air by the metallic package base 21, the metallic package cover 22, the seal ring 3, the feed through units 5 and the optical interface unit 14.

Next, an operation of the optical module will be described below.

A high frequency signal is received in the optical semiconductor element 4 in the same manner as in the first embodiment. Also, electromagnetic waves generated from a part of the high frequency signal are radiated into the cavity 100a of the package 100. Thereafter, the electromagnetic waves are transmitted through the seal element 20 placed on the rear side of the optical module and are received in the electromagnetic wave absorptive element 19, and the electromagnetic waves are converted into heat energy in the electromagnetic wave absorptive element 19.

As is described above, in the second embodiment, the concave area 21a is formed on a side surface of themetallic package base 21 placed on the rear side of the optical module, the electromagnetic wave absorptive element 19 is arranged in the concave area 21a of the metallic package base 21, the electromagnetic wave absorptive element 19 is covered with the seal element 20 to be hermetically sealed from the cavity 100a of the package 100, and the seal element 20 directly faces the cavity 100a of the package 100. Therefore, electromagnetic waves, which are generated from a part of the high frequency signal and are radiated into the cavity 100a of the package 100, are transmitted through the seal element 20 and are converted into heat energy in the electromagnetic wave absorptive element 19. Accordingly, the outgas emitted from the electromagnetic wave absorptive element 19 can be prevented from leaking into the cavity 100a of the package 100, the influence of the cavity resonance on the performance of the optical semiconductor element 4 can be suppressed, and the performance of the optical module can be improved so as to avoid any influence of the cavity resonance on the optical signal.

Also, in the second embodiment, the optical module is covered with the metallic package base 21, the metallic package cover 22 and the seal ring 3 to electro-magnetically separate the optical semiconductor element 4 from external noise. Therefore, the performance of the optical module can be further improved so as to avoid any influence of the external noise on the optical signal.

Embodiment 3

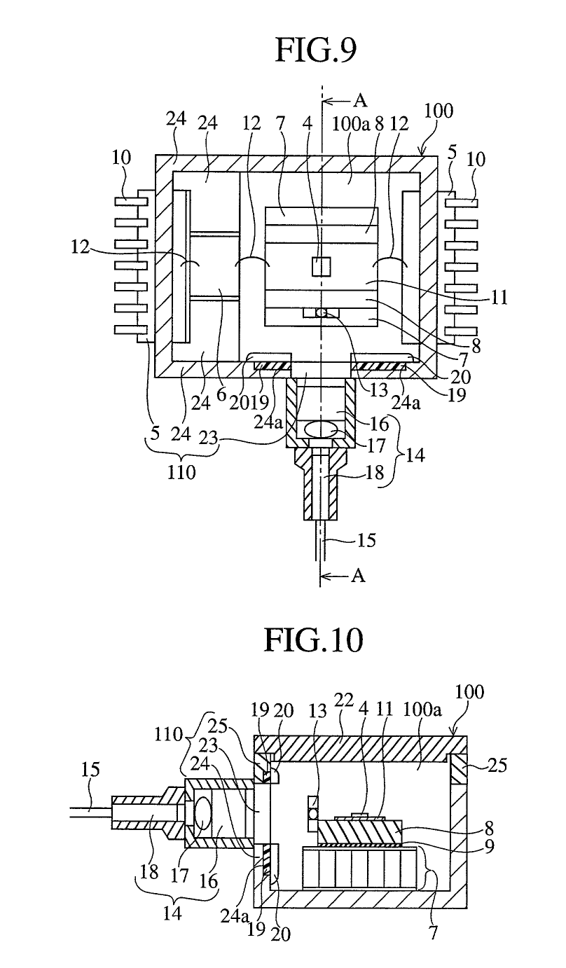

FIG. 9 is a perspective top view of an optical module according to a third embodiment of the present invention, and FIG. 10 is a vertical sectional view taken substantially along line A-A of FIG. 9.

In the first embodiment, the electromagnetic wave absorptive element 19 is arranged in the concave area 2a of the package cover 2 placed on the upper surface of the package 100 of the optical module. In contrast, in a third embodiment, the electromagnetic wave absorptive element 19 is arranged in a concave area which faces inner side surfaces of both a package base and a seal ring placed on the front side of the optical module. The optical interface 14 is placed on the front side of the optical module.

In FIG. 9 and FIG. 10, 24 indicates a metallic package base which forms a bottom wall and side walls of the package 100 of the optical module to shield the optical semiconductor element 4 from external noise. 25 indicates a seal ring connecting the package base 24 and the package cover 22. The electromagnetic wave absorptive element 19 is arranged in a concave area (or a concavity) 24a which faces inner side surfaces of both the package base 24 and the seal ring 25 placed on the front side of the optical module. The electromagnetic wave absorptive element 19 is placed between a front side portion of the package 100 and the seal element 20 and is hermetically sealed from the cavity 100a of the package 100 in the same manner as in the first embodiment. The seal element 20 faces the cavity 100a of the package 100.

Therefore, the cavity 100a of the package 100 is separated from the outside air by the metallic package base 24, the metallic package cover 22, the seal ring 25, the feed through units 5 and the optical interface unit 14.

Next, an operation of the optical module will be described below.

A high frequency signal is received in the optical semiconductor element 4 in the same manner as in the first embodiment. Also, electromagnetic waves generated from a part of the high frequency signal are radiated into the cavity 100a of the package 100. Thereafter, the electromagnetic waves are transmitted through the seal element 20 placed on the front side of the optical module and are received in the electromagnetic wave absorptive element 19, and the electromagnetic waves are converted into heat energy in the electromagnetic wave absorptive element 19.

As is described above, in the third embodiment, the concave area 24a is formed on side surfaces of the metallic package base 24 and the seal ring 25 placed on the front side of the optical module, the electromagnetic wave absorptive element 19 is arranged in the concave area 24a facing the metallic package base 24 and the seal ring 25, the electromagnetic wave absorptive element 19 is covered with the seal element 20 to be hermetically sealed from the cavity 100a of the package 100, and the seal element 20 directly faces the cavity 100a of the package 100. Therefore, electromagnetic waves, which are generated from a part of the high frequency signal and are radiated into the cavity 100a of the package 100, are transmitted through the seal element 20 and are converted into heat energy in the electromagnetic wave absorptive element 19. Accordingly, the outgas emitted from the electromagnetic wave absorptive element 19 can be prevented from leaking into the cavity 100a of the package 100, the influence of the cavity resonance on the performance of the optical semiconductor element 4 can be suppressed, and the performance of the optical module can be improved so as to avoid any influence of the cavity resonance on the optical signal.

Also, in the third embodiment, the optical module is covered with the metallic package base 24, the metallic package cover 22 and the seal ring 25 to electro-magnetically separate the optical semiconductor element 4 from external noise. Therefore, the performance of the optical module can be further improved so as to avoid any influence of the external noise on the optical signal.

Embodiment 4

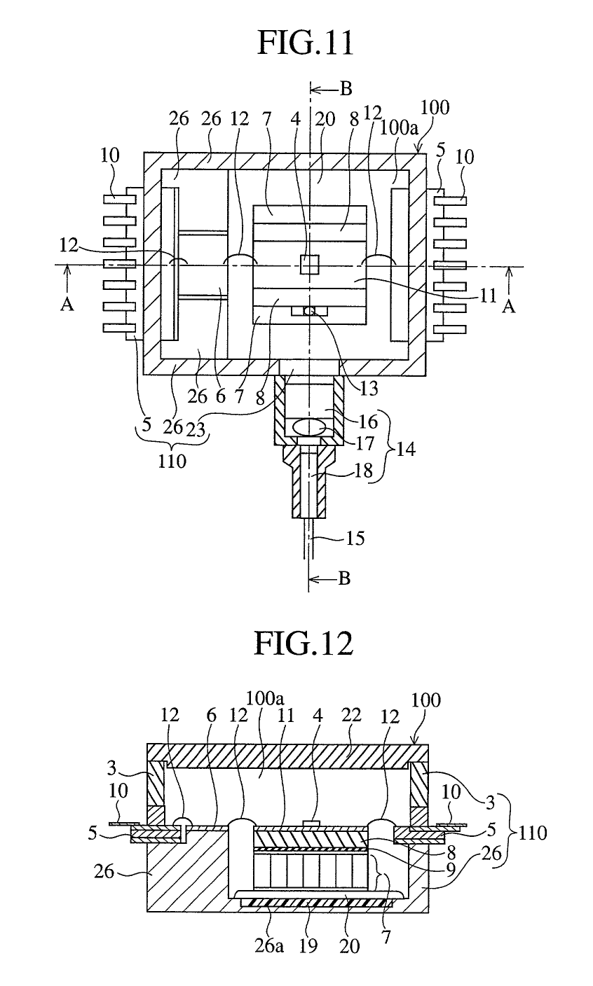

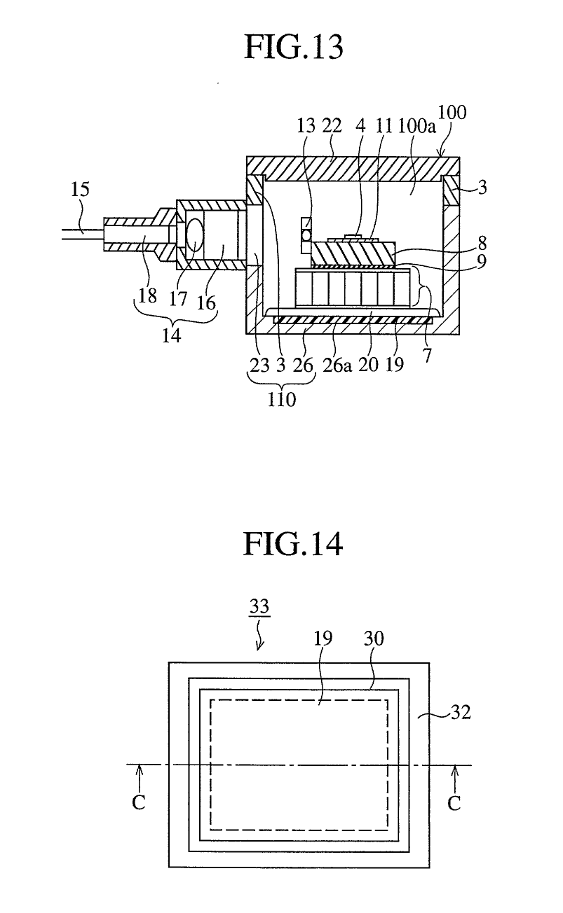

FIG. 11 is a perspective top view of an optical module according to a fourth embodiment of the present invention, FIG. 12 is a vertical sectional view taken substantially along line A-A of FIG. 11, and FIG. 13 is a vertical sectional view taken substantially along line B-B of FIG. 11.

In the first embodiment, the electromagnetic wave absorptive element 19 is arranged in the concave area 2a of the package cover 2 placed on the upper surface of the package 100 of the optical module. In contrast, in a fourth embodiment, the electromagnetic wave absorptive element 19 is arranged in a concave area which faces an inner bottom surface of a package base placed on the bottom side of the optical module.

In FIG. 11, FIG. 12 and FIG. 13, 26 indicates a metallic package base which forms a bottom wall and side walls of the package 100 of the optical module to shield the optical semiconductor element 4 from external noise. The electromagnetic wave absorptive element 19 is arranged in a concave area (or a concavity) 26a which faces an inner bottom surface of the package base 26 placed on the bottom side of the optical module. The electromagnetic wave absorptive element 19 is arranged between the package base 26 and the seal element 20 and is hermetically sealed from the cavity 100a of the package 100 in the same manner as in the first embodiment. The seal element 20 faces the cavity 100a of the package 100.

Therefore, the cavity 100a of the package 100 is separated from the outside air by the metallic package base 26, the metallic package cover 22, the seal ring 3, the feed through units 5 and the optical interface unit 14. Next, an operation of the optical module will be described below.

A high frequency signal is received in the optical semiconductor element 4 in the same manner as in the first embodiment. Also, electromagnetic waves generated from a part of the high frequency signal are radiated into the cavity 100a of the package 100. Thereafter, the electromagnetic waves are transmitted through the seal element 20 placed on the bottom side of the optical module and are received in the electromagnetic wave absorptive element 19, and the electromagnetic waves are converted into heat energy in the electromagnetic wave absorptive element 19.

As is described above, in the fourth embodiment, the concave area 26a is formed on a bottom surface of the metallic package base 26 placed on the bottom side of the optical module, the electromagnetic wave absorptive element 19 is arranged in the concave area 26a of the metallic package base 26, the electromagnetic wave absorptive element 19 is covered with the seal element 20 to be hermetically sealed from the cavity 100a of the package 100, and the seal element 20 directly faces the cavity 100a of the package 100. Therefore, electromagnetic waves, which are generated from a part of the high frequency signal and are radiated into the cavity 100a of the package 100, are transmitted through the seal element 20 and are converted into heat energy in the electromagnetic wave absorptive element 19. Accordingly, the outgas emitted from the electromagnetic wave absorptive element 19 can be prevented from leaking into the cavity 100a of the package 100, the influence of the cavity resonance on the performance of the optical semiconductor element 4 can be suppressed, and the performance of the optical module can be improved so as to avoid any influence of the cavity resonance on the optical signal.

Also, in the fourth embodiment, the optical module is covered with the metallic package base 26, the metallic package cover 22 and the seal ring 3 to electro-magnetically separate the optical semiconductor element 4 from external noise. Therefore, the performance of the optical module can be further improved so as to avoid any influence of the external noise on the optical signal.

In the fourth embodiment, the electromagnetic wave absorptive element 19 is arranged on the whole inner bottom surface of the package base 26. However, it is applicable that the electromagnetic wave absorptive element 19 is arranged on an inner bottom surface of the package base 26 other than a surface of the package base 26 making contact with the constant temperature element 7.

Also, in the first to fourth embodiments, the electromagnetic wave absorptive element 19 hermetically sealed from the cavity 100a of the package 100 by the seal element 20 is arranged on an inner surface of the package cover 2, a rear side surface of the package base 21, front side surfaces of both the package base 24 and the seal ring 25 or a bottom surface of the package base 26. However, it is applicable that the electromagnetic wave absorptive element 19 hermetically sealed from the cavity 100a of the package 100 by the seal element 20 be arranged on any of all inner surfaces of the package 100. Also, it is applicable that the electromagnetic wave absorptive element 19 hermetically sealed from the cavity 100a of the package 100 by the seal element 20 be arranged on each of a plurality of surfaces of the package 100 or on each of all inner surfaces of the package 100 on condition that the reception of the high frequency signal in the optical semiconductor element 4 or the outputting of the optical signal to the optical interface unit 14 is not disturbed by the electromagnetic wave absorptive element 19.

Embodiment 5

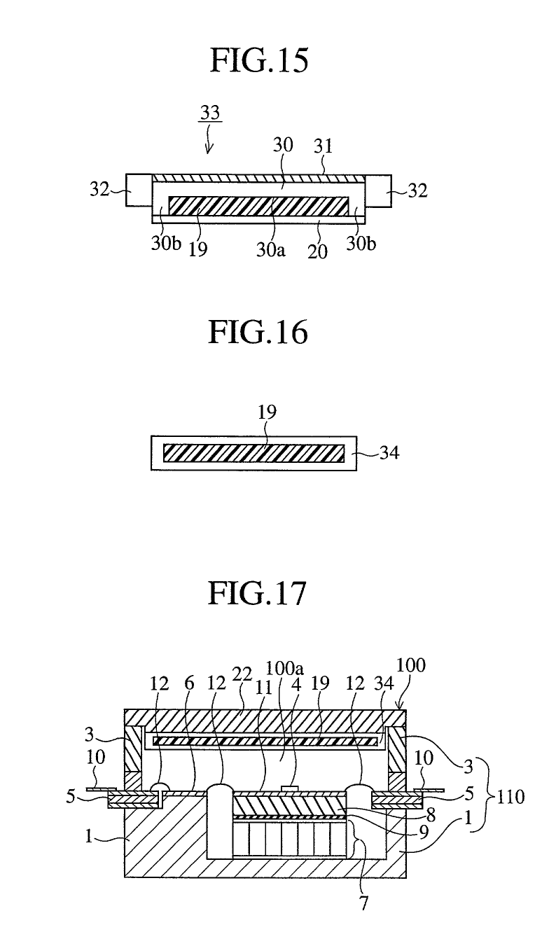

FIG. 14 is a plan view of a package cover, in which the electromagnetic wave absorptive element 19 is arranged, according to a fifth embodiment of the present invention, and FIG. 15 is a vertical sectional view taken substantially along line C-C of FIG. 14.

In FIG. 14 and FIG. 15, 33 indicates a package cover having a combination unit of the electromagnetic wave absorptive element 19, the seal element 20 and a metallized dielectric material.

In the package cover 33, 30 indicates a dielectric substrate formed in a plate shape. The dielectric substrate 30 is formed of a dielectric material such as ceramic or silicon. 31 indicates a metal layer arranged on an outer surface of the dielectric substrate 30. The metal layer 31 is obtained by depositing or coating chromium and/or gold on an outer surface of the dielectric substrate 30. 30a indicates a concave area (or a concavity) placed on a surface of the dielectric substrate 30 opposite to a surface on which the metal layer 31 is arranged. The concave area 30a is opened almost over the whole surface of the dielectric substrate 30. The electromagnetic wave absorptive element 19 is arranged in the concave area 30a of the dielectric substrate 30 and is covered with the seal element 20. The seal element 20 is attached to an end portion 30a of the dielectric substrate 30 surrounding the concave area 30a so as to keep outgas emitted from the electromagnetic wave absorptive element 19 in the concave area 30a. 32 indicates a metal ring attached to a peripheral side surface of the dielectric substrate 30. The dielectric substrate 30 is rimmed with the metal ring 32.

The package cover 33 is arranged in an optical module in place of the package cover 2 shown in FIG. 1B, FIG. 2A and FIG. 2B. In this case, the package cover 33 is arranged so as to make the seal element 20 face the cavity 100a of the package 100 and to direct the metal layer 31 toward the outside. Also, the metal ring 32 is jointed to the seal ring 3 shown in FIG. 1B and FIG. 2A so as to hermetically seal the cavity 100a of the package 100 from the outside air. Therefore, the cavity 100a of the package 100 is separated from the outside air, and no dust is entered into the cavity 100a. Therefore, the influence of dust on the first lens 13 can be prevented. Also, the cavity 100a of the package 100 is separated from the outside air by the metallic package base 1, the metallic package cover 33, the seal ring 3, the feed through units 5 and the optical interface unit 14.

Next, an operation of the optical module will be described below.

A high frequency signal is received in the optical semiconductor element 4 in the same manner as in the first embodiment. Also, electromagnetic waves generated from a part of the high frequency signal are radiated into the cavity 100a of the package 100. Thereafter, the electromagnetic waves are transmitted through the seal element 20 facing the cavity 100a on the upper side of the optical module and are received in the electromagnetic wave absorptive element 19, and the electromagnetic waves are converted into heat energy in the electromagnetic wave absorptive element 19.

As is described above, in the fifth embodiment, the package cover 33 having a combination unit of the electromagnetic wave absorptive element 19, the seal element 20 and a metallized dielectric material is arranged in place of the package cover 2 having the electromagnetic wave absorptive element 19 on the package base 1 through the seal ring 3, and the seal element 20 directly faces the cavity 100a of the package 100. Therefore, the electromagnetic waves are transmitted through the seal element 20 and are converted into heat energy in the electromagnetic wave absorptive element 19. Accordingly, the outgas emitted from the electromagnetic wave absorptive element 19 can be prevented from leaking into the cavity 100a of the package 100, the influence of the cavity resonance on the performance of the optical semiconductor element 4 can be suppressed, and the performance of the optical module can be improved so as to avoid any influence of the cavity resonance on the optical signal.

Also, in the fifth embodiment, the optical module is covered with the metallic package base 1, the metallic package cover 33 and the seal ring 3 to electro-magnetically separate the optical semiconductor element 4 from external noise. Therefore, the performance of the optical module can be further improved so as to avoid any influence of the external noise on the optical signal.

Here, in the fifth embodiment, the package cover 33 having a combination unit of the electromagnetic wave absorptive element 19, the seal element 20 and a metallized dielectric material is arranged on the package base 1 through the seal ring 3 in the same manner as in the first embodiment. However, the fifth embodiment is not limited to the arrangement of the package cover 33 having a combination unit of the electromagnetic wave absorptive element 19, the seal element 20 and a metallized dielectric material. For example, it is applicable that a combination unit of the electromagnetic wave absorptive element 19, the seal element 20 and a metallized dielectric material be arranged on the rear side surface of the package 100 in the same manner as in the second embodiment. Also, it is applicable that a combination unit of the electromagnetic wave absorptive element 19, the seal element 20 and a metallized dielectric material be arranged on the front side surface of the package 100 in the same manner as in the third embodiment. Also, it is applicable that a combination unit of the electromagnetic wave absorptive element 19, the seal element 20 and ametallized dielectric material be arranged on the bottom side surface of the package 100 in the same manner as in the fourth embodiment. Also, it is applicable that a combination unit of the electromagnetic wave absorptive element 19, the seal element 20 and a metallized dielectric material be arranged on any surface of the package 100. Also, it is applicable that a combination unit of the electromagnetic wave absorptive element 19, the seal element 20 and a metallized dielectric material be arranged on each of a plurality of surfaces of the package 100 or on each of all surfaces of the package 100 on condition that the reception of the high frequency signal in the optical semiconductor element 4 or the outputting of the optical signal to the optical interface unit 14 is not disturbed.

Embodiment 6

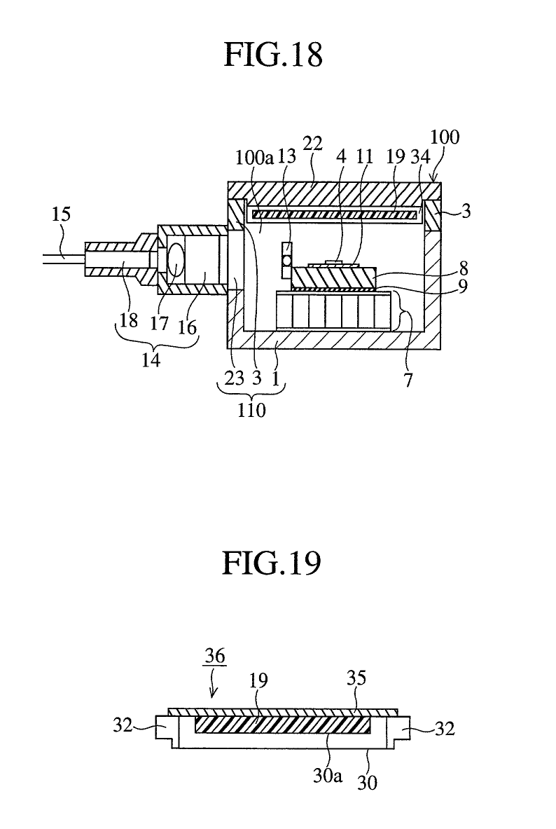

FIG. 16 is a vertical sectional view of the electromagnetic wave absorptive element 19 hermetically coated according to a sixth embodiment of the present invention, FIG. 17 is a vertical sectional view taken substantially along line A-A of FIG. 1A according to the sixth embodiment to show the hermetically-coated electromagnetic wave absorptive element 19 arranged on a package cover of an optical module, and FIG. 18 is a vertical sectional view taken substantially along line B-B of FIG. 1A according to the sixth embodiment to show the hermetically-coated electromagnetic wave absorptive element 19 arranged on a package cover of an optical module.

In FIG. 16, FIG. 17 and FIG. 18, all surfaces of the electromagnetic wave absorptive element 19 are hermetically coated with an inactive material (for example, silicon which is the same material as that of the seal element 20). The inactive material does not emit outgas but is transmitted electromagnetic waves. Therefore, the electromagnetic wave absorptive element 19 is hermetically sealed by a coating layer 34. The electromagnetic wave absorptive element 19 hermetically sealed by the coating layer 34 is attached to an inner surface of the package cover 22 so as to make the coating layer 34 face the cavity 100a of the package 100. The cavity 100a of the package 100 is separated from the outside air by the metallic package base 1, the metallic package cover 22, the seal ring 3, the feed through units 5 and the optical interface unit 14.

Next, an operation of the optical module will be described below.

A high frequency signal is received in the optical semiconductor element 4 in the same manner as in the first embodiment. Also, electromagnetic waves generated from a part of the high frequency signal are radiated into the cavity 100a of the package 100. Thereafter, the electromagnetic waves are transmitted through the coating layer 34 facing the cavity 100a on the upper side of the optical module and are received in the electromagnetic wave absorptive element 19, and the electromagnetic waves are converted into heat energy in the electromagnetic wave absorptive element 19.

As is described above, in the sixth embodiment, the electromagnetic wave absorptive element 19 hermetically sealed by the coating layer 34 is arranged on an inner surface of the package cover 22 so as to face the cavity 100a of the package 100. Therefore, the electromagnetic waves are transmitted through the coating layer 34 and are converted into heat energy in the electromagnetic wave absorptive element 19. Accordingly, because it is not required to form a concave area in the package cover 22, the outgas emitted from the electromagnetic wave absorptive element 19 can be prevented from leaking into the cavity 100a of the package 100 in a simplified sealing structure, the influence of the cavity resonance on the performance of the optical semiconductor element 4 can be suppressed, and the performance of the optical module can be improved so as to avoid any influence of the cavity resonance on the optical signal.

Also, in the sixth embodiment, the optical module is covered with the metallic package base 1, the metallic package cover 22 and the seal ring 3 to electro-magnetically separate the optical semiconductor element 4 from external noise. Therefore, the performance of the optical module can be further improved so as to avoid any influence of the external noise on the optical signal.

Embodiment 7

FIG. 19 is a vertical sectional view of a package cover, in which the electromagnetic wave absorptive element 19 is arranged, according to a seventh embodiment of the present invention.

In FIG. 19, 36 indicates a package cover having a metal layer, the electromagnetic wave absorptive element 19 and a dielectric material. In the package cover 36, 30 indicates the dielectric substrate formed in a plate shape. The dielectric substrate 30 is formed of a dielectric material such as ceramic or silicon. 30a indicates the concave area 30a opened almost over the whole surface of the dielectric substrate 30. The electromagnetic wave absorptive element 19 is arranged in the concave area 30a of the dielectric substrate 30.32 indicates the metal ring attached to a peripheral side surface of the dielectric substrate 30. The dielectric substrate 30 is rimmed with the metal ring 32. 35 indicates a metal layer. Both the dielectric substrate 30 and the electromagnetic wave absorptive element 19 arranged in the concave area 30a of the dielectric substrate 30 are covered with the metal layer 35 to hermetically seal the electromagnetic wave absorptive element 19 and to keep outgas emitted from the electromagnetic wave absorptive element 19 in the concave area 30a. The metal layer 35 is jointed to the metal ring

The package cover 36 is arranged in an optical module in place of the package cover 2 shown in FIG. 1B, FIG. 2A and FIG. 2B. In this case, the package cover 36 is arranged so as to make the dielectric substrate 30 face the cavity 100a of the package 100 and to direct the metal layer 35 toward the outside. Also, the metal ring 32 is jointed to the seal ring 3 shown in FIG. 1B and FIG. 2A so as to hermetically seal the cavity 100a of the package 100 from the outside air. Therefore, the cavity 100a of the package 100 is separated from the outside air, and no dust enters into the cavity 100a. Therefore, the influence of dust on the first lens 13 can be prevented. The dielectric substrate 30 also functions as a structural layer to increase a mechanical strength of the package cover 36.

Also, the cavity 100a of the package 100 is separated from the outside air by the metallic package base 1, the metallic package cover 36, the seal ring 3, the feed through units 5 and the optical interface unit 14.

Next, an operation of the optical module will be described below.

A high frequency signal is received in the optical semiconductor element 4 in the same manner as in the first embodiment. Also, electromagnetic waves generated from a part of the high frequency signal are radiated into the cavity 100a of the package 100. Thereafter, the electromagnetic waves are transmitted through the dielectric substrate 30 facing the cavity 100a on the upper side of the optical module and are received in the electromagnetic wave absorptive element 19, and the electromagnetic waves are converted into heat energy in the electromagnetic wave absorptive element 19.

As is described above, in the seventh embodiment, the package cover 36 having a combination unit of the metal layer 35, the electromagnetic wave absorptive element 19 and the dielectric material 30 is arranged in place of the package cover 2 having the electromagnetic wave absorptive element 19 on the package base 1 through the seal ring 3, and the dielectric material 30 directly faces the cavity 100a of the package 100. Therefore, the electromagnetic waves are transmitted through the dielectric material 30 and are converted into heat energy in the electromagnetic wave absorptive element 19. Accordingly, the outgas emitted from the electromagnetic wave absorptive element 19 can be prevented from leaking into the cavity 100a of the package 100, the influence of the cavity resonance on the performance of the optical semiconductor element 4 can be suppressed, and the performance of the optical module can be improved so as to avoid any influence of the cavity resonance on the optical signal.

Also, in the seventh embodiment, the optical module is covered with the metallic package base 1, the package cover 36 and the seal ring 3 to electro-magnetically separate the optical semiconductor element 4 from external noise. Therefore, the performance of the optical module can be further improved so as to avoid any influence of the external noise on the optical signal.

Here, in the seventh embodiment, the package cover 36 having a combination unit of the metal layer 35, the electromagnetic wave absorptive element 19 and the dielectric material 30 is arranged on the package base 1 through the seal ring 3 in the same manner as in the first embodiment. However, the seventh embodiment is not limited to the arrangement of the package cover 36 having a combination unit of the metal layer 35, the electromagnetic wave absorptive element 19 and the dielectric material 30. For example, it is applicable that a combination unit of the metal layer 35, the electromagnetic wave absorptive element 19 and the dielectric material 30 be arranged on the rear side surface of the package 100 in the same manner as in the second embodiment. Also, it is applicable that a combination unit of the metal layer 35, the electromagnetic wave absorptive element 19 and the dielectric material 30 be arranged on the front side surface of the package 100 in the same manner as in the third embodiment. Also, it is applicable that a combination unit of the metal layer 35, the electromagnetic wave absorptive element 19 and the dielectric material 30 be arranged on the bottom side surface of the package 100 in the same manner as in the fourth embodiment. Also, it is applicable that a combination unit of the metal layer 35, the electromagnetic wave absorptive element 19 and the dielectric material 30 be arranged on any surface of the package 100. Also, it is applicable that a combination unit of the metal layer 35, the electromagnetic wave absorptive element 19 and the dielectric material 30 be arranged on each of a plurality of surfaces of the package 100 or on each of all surfaces of the package 100 on condition that the reception of the high frequency signal in the optical semiconductor element 4 or the outputting of the optical signal to the optical interface unit 14 is not disturbed.

Embodiment 8

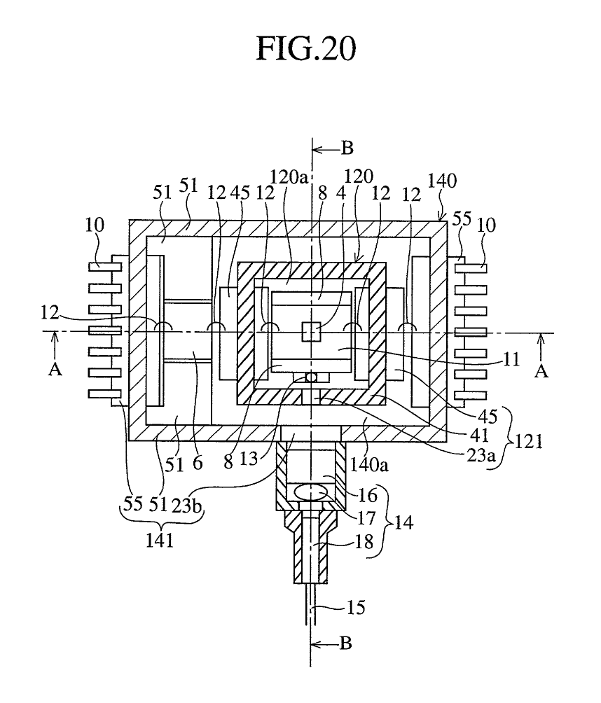

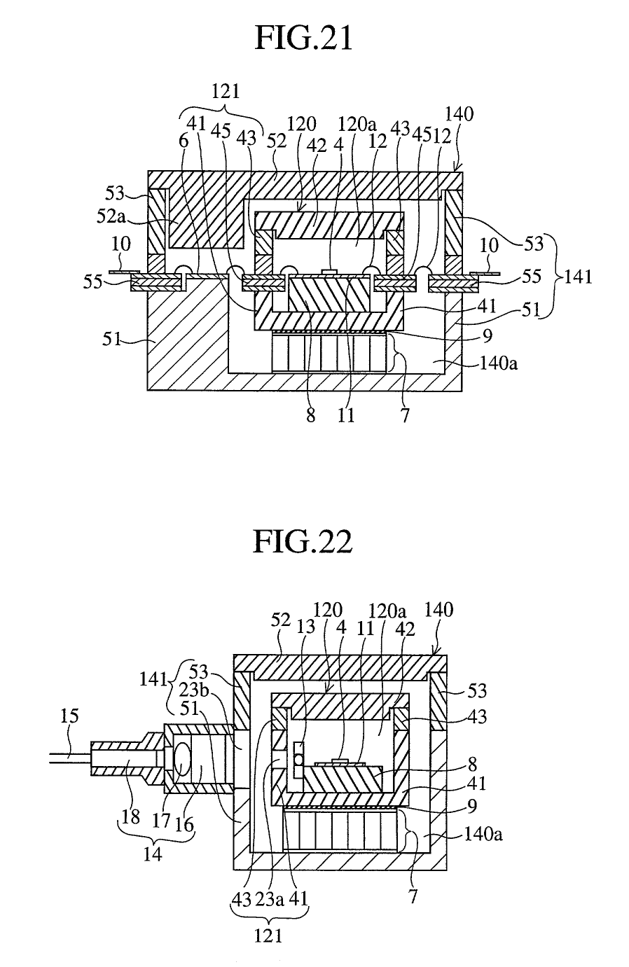

FIG. 20 is a perspective top view of an optical module according to an eight embodiment of the present invention, FIG. 21 is a vertical sectional view taken substantially along line A-A of FIG. 20 according to the eighth embodiment, and FIG. 22 is a vertical sectional view taken substantially along line B-B of FIG. 20 according to the eighth embodiment.

In the first embodiment, the optical semiconductor element 4, the driver IC 6, the constant temperature element 7, the metal carrier 8, the insulator 9, the substrate 11, the first lens 13 and the electromagnetic wave absorptive element 19 are arranged in the metallic package 100 formed in a single structure. In contrast, in an eighth embodiment, an optical module has a double package structure, and the double package structure of the optical module is formed of an inner metallic package (hereinafter, called a first package) 120 and an outer metallic package (hereinafter, called a second package) 140 surrounding the first package 120. The optical semiconductor element 4, the metal carrier 8, the substrate 11 and the first lens 13 are arranged in the first package 120, and the driver IC 6, the constant temperature element 7 and the insulator 9 are arranged in a space between the first package 120 and the second package 140. The structure of the optical module according to the eighth embodiment will be described in detail.

In FIG. 20, FIG. 21 and FIG. 22, 41 indicates a first package base formed of metal. 42 indicates a first package cover formed of metal. The first package cover 42 is placed above the first package base 41. 43 indicates a first seal ring which connects the first package base 41 and the first package cover 42 so as to hermetically seal an inner space surrounded by the first package base 41, the first package cover 42 and the first seal ring 43 from the outside. 45 indicates a first feed through unit through which a high frequency signal is lead to the optical semiconductor element 4. The first feed through unit 45 is arranged between the first package base 41 and the first seal ring 43 on each of both sides (right and left sides in FIG. 20) of the first package 120. Each feed through unit 45 is, for example, brazed to the package base 41 and the first seal ring 43. 23a indicates a first optical window through which the optical signal output from the optical semiconductor element 4 is transmitted. The first optical window 23a is jointed to the first package base 41 so as to occupy an opening hole of the first package base 41. Asize of the first optical window 23a is sufficiently small as compared with a size of the first package base 41, and an opening diameter of the first optical window 23a is equal to or slightly larger than that of the first lens 13 so as not to disturb the transmission of the optical signal.

Here, a first package box 121 is composed of the first package base 41, the first seal ring 43, the first feed through units 45 and the first optical window 23a. Also, the first package box 121 is jointed to the first package cover 42, and the first package 120 is composed of the first package box 121 and the first package cover 42. The first package 120 has a first cavity 120a. The first cavity 120a is separated from the outside air by the first package box 121 and the first package cover 42. In the first package 120, the optical semiconductor element 4, the metal carrier 8, the substrate 11 and the first lens 13 are operated in the same manner as in the first embodiment.

Also, 51 indicates a second package base formed of metal. 52 indicates a second package cover formed of metal. The second package cover 52 is placed above the second package base 51. In this case, there is a probability that cavity resonance occurs in a space between the second package 140 and the first package 120. The occurrence of the cavity resonance depends on a relationship between a frequency of the high frequency signal transmitting through the space and a size or shape of the space. To reduce an adverse influence of the cavity resonance on elements arranged in the space, it is required to reduce the space to a size smaller than a prescribed space size in which the occurrence of the cavity resonance is suppressed. Therefore, as shown in FIG. 21, the second package cover 52 has a protrusive portion 52a extending toward the driver IC 6 at an inlet position of the high frequency signal on the left side of the second package 140 to reduce the space to a size smaller than the prescribed space size.

53 indicates a second seal ring which connects the second package base 51 and the second package cover 52 so as to hermetically seal an inner space surrounded by the second package base 51, the second package cover 52 and the second seal ring 53 from the outside. 55 indicates a second feed through unit through which the high frequency signal is lead to the driver IC 6. The second feed through unit 55 is arranged between the second package base 51 and the second seal ring 53 on each of both sides (right and left sides in FIG. 20) of the second package 140. Each feed through unit 55 is, for example, brazed to the package base 51 and the second seal ring 53. 23b indicates a second optical window through which the optical signal transmitting through the first optical window 23a is transmitted. The second optical window 23b is jointed to the second package base 51 and the second seal ring 53 so as to occupy an opening hole arranged between the second package base 51 and the second seal ring 53. A size of the second optical window 23b is larger than a size of the first optical window 23a.

Here, a second package box 141 is composed of the second package base 51, the second seal ring 53, the second feed through units 55 and the second optical window 23b. Also, the second package box 141 is jointed to the second package cover 52, and the second package 140 is composed of the second package box 141 and the second package cover 52. The second package 140 surrounds the first package 120, and a second cavity 140a is formed between the second package 140 and the first package 120. The second cavity 140a is separated from the outside air by the second package box 141 and the second package cover 52. In the second package 140, the driver IC 6 is arranged in a narrow area placed on the second package base 51 between the first feed through unit 45 and the second feed through unit 55 on the left side. Therefore, the high frequency signal is transmitted through the second feed through unit 55, the driver IC 6 and the first feed through unit 45 in that order and is received in the optical semiconductor element 4.

Also, on the left side of the optical module, the connecting wires 12 connect the second feed through unit 55 and the driver IC 6, connect the driver IC 6 and the first feed through unit 45 and connect the first feed through unit 45 and the substrate 11. On the right side of the optical module, the connecting wires 12 connect the second feed through unit 55 and the first feed through unit 45 and connect the first feed through unit 45 and the substrate 11. Therefore, the high frequency signal is transmitted through one lead terminal 10, the second feed through unit 55, one connecting wire 12, the driver IC 6, one connecting wire 12, the first feed through unit 45, one connecting wire 12 and the substrate 11 on the left side of the optical module and is received in the optical semiconductor element 4. Also, a voltage signal is transmitted through one lead terminal 10, the second feed through unit 55, one connecting wire 12, the first feed through unit 45, one connecting wire 12 and the substrate 11 on the right side of the optical module and is received in the optical semiconductor element 4. Therefore, the optical semiconductor element 4 is operated according to the high frequency signal and the voltage signal in the same manner as in the first embodiment.

The constant temperature element 7 and the insulator 9 are arranged between the first package base 41 and the second package base 51, and the constant temperature element 7 is insulated by the insulator 9 from the first package 120 and the constituent elements arranged in the first package 120. An electric signal transmitted into the second package 140 through one second feed through unit 55 is received in the constant temperature element 7 through a connecting wire (not shown), and the constant temperature element 7 is operated so as to keep a temperature of the optical semiconductor element 4 to a constant value.

Also, in a front side surface of the second package 140 (on a lower side of the second package 140 in FIG. 20), a base portion (or a portion positioned on an end side of the optical isolator 16) of the optical interface unit 14 is jointed to the second package base 51 and the second seal ring 53 so as to surround a peripheral area of the second optical window 23b arranged between the second package base 51 and the second seal ring 53.

Next, a size of the first cavity 120a of the first package 120 and a size of the second cavity 140a of the second package 140 are described.

Because the first package 120 is placed in the second package 140, a space between the second package 140 and the first package 120 is much smaller than an internal space of the package 100 of the first embodiment. Also, because the protrusive portion 52a of the second package cover 52 extends near to the driver IC 6, an inlet space (in which the high frequency signal received at one lead terminal 10 of the second feed through unit 55 is output to the first feed through unit 45 through the driver IC 6) of the high frequency signal is reduced. Therefore, the second cavity 140a between the second package 140 and the first package 120 is much smaller than the cavity 100a of the package 100 of the first embodiment.

Also, the constant temperature element 7 having a large capacity is not arranged in the first package 120. Also, though a size of a package having the driver IC 6 is increased due to the driver IC 6, the driver IC 6 is not arranged in the first package 120. Therefore, the first cavity 120a of the first package 120, in which the optical semiconductor element 4 is arranged, is much smaller than the cavity 100a of the package 100 of the first embodiment.

Next, an operation of the optical module will be described below.

When an electric signal (hereinafter, call a high frequency signal) including a high frequency signal is received at one lead terminal 10 placed on the left side of the optical module, the high frequency signal is transmitted through the second cavity 140a of the second package 140. Thereafter, the high frequency signal is transmitted through the first cavity 120a of the first package 120 and is received in the optical semiconductor element 4, and an optical signal is output from the optical semiconductor element 4. In this case, a part of the high frequency signal transmitting through the second cavity 140a of the second package 140 leaks into the second cavity 140a as electromagnetic waves, and the electromagnetic waves are reflected on inner walls of the second package 140 and outer walls of the first package 120. However, because a size of the second cavity 140a is small, the occurrence of the cavity resonance due to the high frequency signal leaking into the second cavity 140a is suppressed.

Also, a part of the high frequency signal transmitting through thefirstcavity 120aof thefirstpackage1201eaks into the first cavity 120a as electromagnetic waves, and the electromagnetic waves are reflected on inner walls of the first package 120. However, because a size of the first cavity 120a is small, the occurrence of the cavity resonance due to the high frequency signal leaking into the first cavity 120a is suppressed.

The optical signal output from the optical semiconductor element 4 is converged in the first lens 13 and is transmitted through the first optical window 23a and the second optical window 23b. Thereafter, the optical signal is transmitted through the optical isolator 16 of the optical interface unit 14 and is converged in the second lens 17. Thereafter, the optical signal is transmitted through the ferrule 18 and is coupled to the optical fiber 15 at an end surface of the ferrule 18, and the optical signal is transmitted through the optical fiber 15. Therefore, the optical signal output from the optical semiconductor element 4 can be sent to the optical interface unit 14, which is jointed to the second package 140 at the outside of the second package 140, through the first cavity 120a and the second cavity 140a.

As is described above, in the eighth embodiment, the optical module is formed in a structure of the double packages by arranging both the first package 120 and the second package 140 surrounding the first package 120, and the constant temperature element 7 and the driver IC 6 are arranged in a space between the first package 120 and the second package 140. Therefore, the first cavity 120a of the first package 120 and the second cavity 140a between the first package 120 and the second package 140 respectively have a small size. Accordingly, because a minimum frequency required to generate cavity resonance in each of the first cavity 120a and the second cavity 140a is heightened to a value higher than a frequency (ranging from a frequency of a direct current to a frequency of a microwave or a millimeter wave) of the high frequency signal transmitting through the second cavity 140a and the first cavity 120a, the influence of the cavity resonance on the performance of the optical semiconductor element 4 can be suppressed, and the performance of the optical module can be improved so as to avoid any influence of the cavity resonance on the optical signal.

Also, in the eighth embodiment, the occurrence of the cavity resonance in the neighborhood of the optical semiconductor element 4 can be further reliably prevented, and electromagnetic interference of the electromagnetic waves with the optical semiconductor element 4 and the driver IC 6 can be suppressed. Also, because the optical module is formed in a structure of the double packages, external noise can be further reliably cut off from the optical semiconductor element 4.

Also, in the eighth embodiment, because the protrusive portion 52a of the second package cover 52 is arranged so as to narrow the second cavity 140a, a size of the second cavity 140a, in which the driver IC 6 is arranged, is reduced, and the adverse influence of the cavity resonance in the second cavity 140a can be further suppressed. Here, it is preferred that a size and shape of each of the first and second cavities 120a and 140a is appropriately set in a range that the optical signal output from the optical semiconductor element 4 is not influenced by the cavity resonance.

Also, in the eighth embodiment, no electromagnetic wave absorptive element relating to the occurrence of outgas is arranged in the first package 120 or the second package 140. Therefore, the emission of outgas in the first package 120 and the second package 140 can be reliably prevented, and the performance of the optical module can be improved so as to avoid any influence of the outgas on the optical signal.

Also, in the eighth embodiment, the optical semiconductor element 4 is electro-magnetically separated from the outside by the double metallic packages, the optical semiconductor element 4 can be further reliably shielded from the external noise, and the performance of the optical module can be improved so as to avoid any influence of the external noise on the optical signal.

Embodiment 9

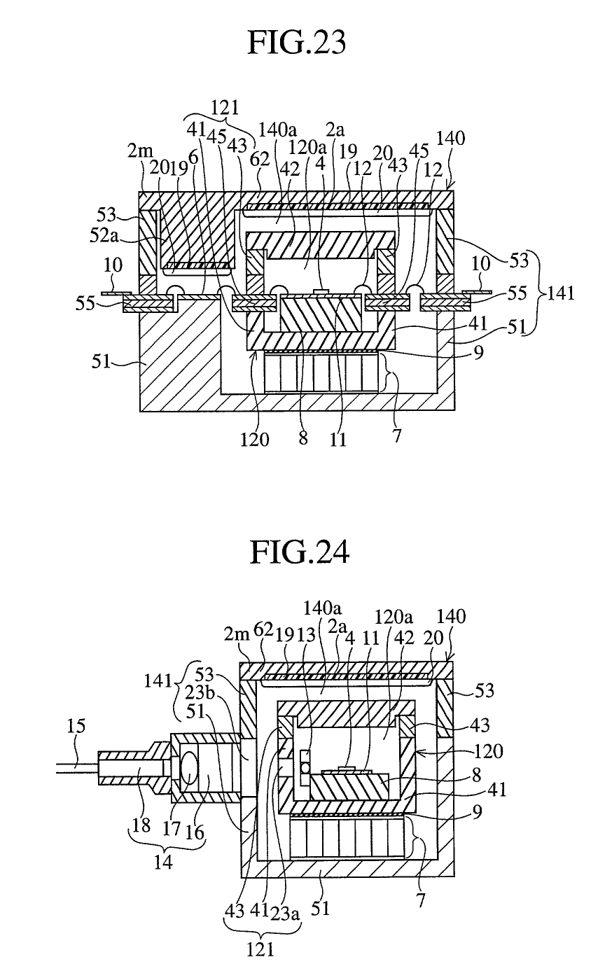

FIG. 23 is a vertical sectional view taken substantially along line A-A of FIG. 20 according to a ninth embodiment of the present invention, and FIG. 24 is a vertical sectional view taken substantially along line B-B of FIG. 20 according to the ninth embodiment.

In FIG. 23 and FIG. 24, 62 indicates a second package cover jointed to the second seal ring 53 to be arranged on the second package base 51 through the second seal ring 53. The second package cover 62 includes the metal substrate 2m in the same manner as the package cover 2 shown in FIG. 1B and FIG. 2A, and the concave area 2a is formed on the inner surface of the metal substrate 2m of the second package cover 62 so as to face the second cavity 140a of the second package 140. The electromagnetic wave absorptive element 19 is arranged in the concave area 2a of the metal substrate 2m of the second package cover 62, and the seal element 20 is arranged on the electromagnetic wave absorptive element 19 so as to hermetically seal the electromagnetic wave absorptive element 19 from the second cavity 140a. Therefore, the seal element 20 directly faces the second cavity 140a, and the second package cover 62, the electromagnetic wave absorptive element 19 and the seal element 20 are arranged as a unit.

In this embodiment, the electromagnetic wave absorptive element 19 hermetically sealed by the seal element 20 is divided into two parts, one part of the electromagnetic wave absorptive element 19 hermetically sealed by the seal element 20 is arranged just above the first package cover 42 of the first package 120, and the other part of the electromagnetic wave absorptive element 19 hermetically sealed by the seal element 20 is attached to a surface of the extending portion 52a of the second package cover 52 so as to be arranged just above the driver IC 6.

Next, an operation of the optical module will be described below.

In the same manner as in the eighth embodiment, inner gas of the second cavity 140a of the second package 140 is separated from the outside air by the optical window 23b, the second package box 141 and the second package cover 62 jointed to the second package box 141. Electromagnetic waves generated from a part of the high frequency signal leaking into the second cavity 140a are reflected on inner walls of the second package 140 and outer walls of the first package 120 in the second cavity 140a. Thereafter, the electromagnetic waves are transmitted through the seal element 20 directly facing the second cavity 140a and are converted into heat energy in the electromagnetic wave absorptive element 19.

As is described above, in the ninth embodiment, the optical module is formed in a structure of the double packages by arranging both the first package 120 and the second package 140 surrounding the first package 120, the electromagnetic wave absorptive element 19 is arranged in the concave area 2a formed on an inner surface of the second package cover 62 placed on the upper side of the second package 140, the electromagnetic wave absorptive element 19 is covered with the seal element 20 so as to be hermetically sealed from the second cavity 140a, and the seal element 20 directly faces the second cavity 140a. Therefore, the electromagnetic waves, which are generated from the high frequency signal and are radiated into the second cavity 140a, are transmitted through the seal element 20 and are converted into heat energy in the electromagnetic wave absorptive element 19. Accordingly, as compared with the eighth embodiment, the influence of the cavity resonance on the performance of the optical semiconductor element 4 can be further suppressed, and the performance of the optical module can be improved so as to avoid any influence of the cavity resonance on the optical signal.

Also, in the ninth embodiment, the electromagnetic wave absorptive element 19 hermetically sealed by the seal element 20 is arranged on the outside of the first package 120 in which the optical semiconductor element 4 and the first lens 13 are arranged, there is no probability that the performance of the optical semiconductor element 4 or the first lens 13 is degraded due to outgas emitted from the electromagnetic wave absorptive element 19. Also, the electromagnetic wave absorptive element 19 is arranged in the concave area 2a of the second package cover 62 so as to be hermetically sealed from the second cavity 140a by the seal element 20. Therefore, no outgas emitted from the electromagnetic wave absorptive element 19 leaks into the second cavity 140a of the second package 140. Accordingly, the performance of the optical semiconductor element 4 or the first lens 13 can be prevented from deteriorating due to the outgas.

In the ninth embodiment, the electromagnetic wave absorptive element 19 hermetically sealed by the seal element 20 is divided into two parts. However, the ninth embodiment is not limited to this arrangement of a combination unit of the electromagnetic wave absorptive element 19 and the seal element 20. That is, it is applicable that a combination unit of the electromagnetic wave absorptive element 19 and the seal element 20 be arranged only at one position. Also, it is applicable that a plurality of combination units of electromagnetic wave absorptive elements 19 and seal elements 20 be separately arranged at a plurality of positions placed on the surface of the second package cover 62 respectively.

Also, in the ninth embodiment, a combination unit of the electromagnetic wave absorptive element 19 and the seal element 20 is arranged on an inner surface of the second package cover 62 of the second package 140. However, the present invention is not limited to this arrangement of the combination unit. For example, in the same manner as in the second to fourth embodiments, it is applicable that the combination unit of the electromagnetic wave absorptive element 19 and the seal element 20 be arranged on any inner surface of the second package 140 of the optical module. Also, it is applicable that the combination unit of the electromagnetic wave absorptive element 19 and the seal element 20 be arranged on a plurality of inner surfaces or all inner surfaces of the second package 140 of the optical module on condition that the reception of the high frequency signal in the optical semiconductor element 4 or the outputting of the optical signal to the optical interface unit 14 is not disturbed by the combination unit of the electromagnetic wave absorptive element 19 and the seal element 20.

Also, in the ninth embodiment, the combination unit of the electromagnetic wave absorptive element 19 and the seal element 20, which is the same as that shown in FIG. 1A, FIG. 2A and FIG. 2B, is arranged. However, it is applicable that the combination unit of the electromagnetic wave absorptive element 19, the seal element 20 and a metallized dielectric material shown in FIG. 14 and FIG. 15 be arranged in place of the combination unit of the electromagnetic wave absorptive element 19 and the seal element 20. Also, it is applicable that the combination unit of the metal layer 35, the electromagnetic wave absorptive element 19 and the dielectric material 30 shown in FIG. 19 be arranged in place of the combination unit of the electromagnetic wave absorptive element 19 and the seal element 20.

Embodiment 10

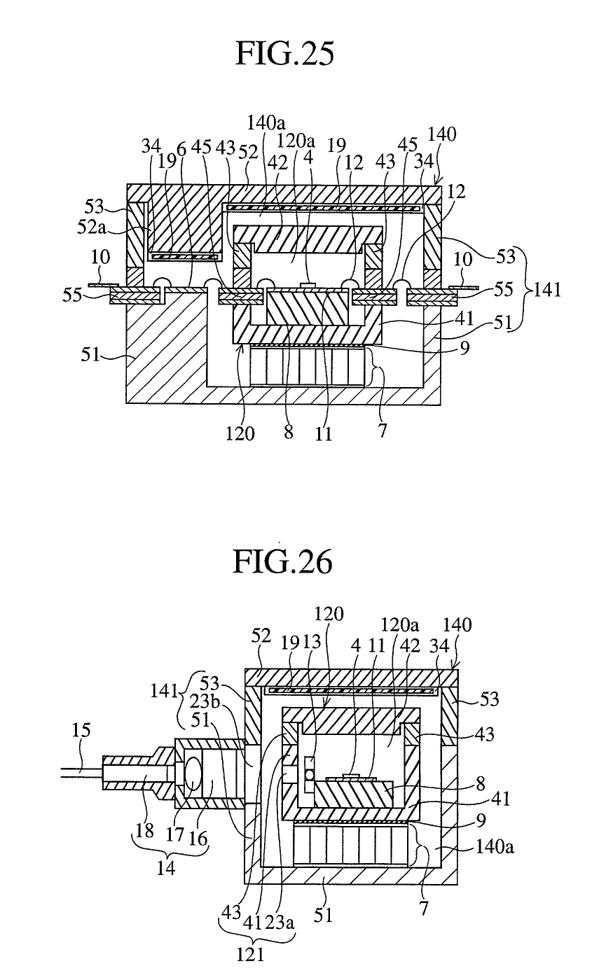

FIG. 25 is a vertical sectional view taken substantially along line A-A of FIG. 20 according to a tenth embodiment of the present invention, and FIG. 26 is a vertical sectional view taken substantially along line B-B of FIG. 20 according to the tenth embodiment.

An optical module of the tenth embodiment differs from that of the eighth embodiment in that the electromagnetic wave absorptive element 19 hermetically sealed by the coating layer 34 is attached to an inner surface of the second package cover 52, in the same manner as in the sixth embodiment, so as to make the coating layer 34 directly face the second cavity 140a of the second package 140.

In this embodiment, the electromagnetic wave absorptive element 19 hermetically sealed by the coating layer 34 is divided into two parts, one part of the electromagnetic wave absorptive element 19 sealed by the coating layer 34 is arranged just above the first package cover 42 of the first package 120, and the other part of the electromagnetic wave absorptive element 19 sealed by the coating layer 34 is attached to a surface of the extending portion 52a of the second package cover 52 so as to be arranged just above the driver IC 6.

Next, an operation of the optical module of the tenth embodiment will be described.

Electromagnetic waves generated from the high frequency signal in the same manner as in the sixth embodiment are radiated into the second cavity 140a of the second package 140. Thereafter, the electromagnetic waves are transmitted through the coating layer 34 directly facing the second cavity 140a and are converted into heat energy in the electromagnetic wave absorptive element 19.

As is described above, in the tenth embodiment, the optical module is formed in a structure of the double packages by arranging both the first package 120 and the second package 140 surrounding the first package 120, and the electromagnetic wave absorptive element 19 hermetically sealed by the coating layer 34 is attached to an inner surface of the second package cover 52—so as to make the coating layer 34 directly face the second cavity 140a of the second package 140. Therefore, the electromagnetic waves radiated into the second cavity 140a are transmitted through the coating layer 34 and are converted into heat energy in the electromagnetic wave absorptive element 19. Accordingly, as compared with the eighth embodiment, the influence of the cavity resonance on the performance of the optical semiconductor element 4 can be further suppressed, and the performance of the optical module can be improved so as to avoid any influence of the cavity resonance on the optical signal.

Also, in the tenth embodiment, the electromagnetic wave absorptive element 19 hermetically sealed by the coating layer 34 is arranged on the outside of the first package 120 in which the optical semiconductor element 4 and the first lens 13 are arranged, there is no probability that the performance of the optical semiconductor element 4 or the first lens is degraded due to outgas emitted from the electromagnetic wave absorptive element 19. Also, the electromagnetic wave absorptive element 19 hermetically sealed by the coating layer 34 is arranged, no outgas emitted from the electromagnetic wave absorptive element 19 leaks into the second cavity 140a of the second package 140. Accordingly, the deterioration of the performance of the optical semiconductor element 4 or the first lens 13 due to the outgas can be prevented.

In the tenth embodiment, the electromagnetic wave absorptive element 19 hermetically sealed by the coating layer 34 is divided into two parts. However, the tenth embodiment is not limited to this arrangement of a combination unit of the electromagnetic wave absorptive element 19 and the coating layer 34. That is, it is applicable that a combination unit of the electromagnetic wave absorptive element 19 and the coating layer 34 be arranged only at one position. Also, it is applicable that a plurality of combination units of electromagnetic wave absorptive elements 19 and coating layers 34 be separately arranged at a plurality of positions placed on the surface of the second package cover 62 respectively.

Also, in the tenth embodiment, a combination unit of the electromagnetic wave absorptive element 19 and the coating layer 34 is arranged on an inner surface of the second package cover 62 of the second package 140. However, the present invention is not limited to this arrangement of the combination unit. For example, in the same manner as in the second to fourth embodiments, it is applicable that the combination unit of the electromagnetic wave absorptive element 19 and the coating layer 34 be arranged on any inner surface of the second package 140 of the optical module. Also, it is applicable that the combination unit of the electromagnetic wave absorptive element 19 and the coating layer 34 be arranged on a plurality of inner surfaces or all inner surfaces of the second package 140 of the optical module on condition that the reception of the high frequency signal in the optical semiconductor element 4 or the outputting of the optical signal to the optical interface unit 14 is not disturbed by the combination unit of the electromagnetic wave absorptive element 19 and the coating layer 34.

Embodiment 11

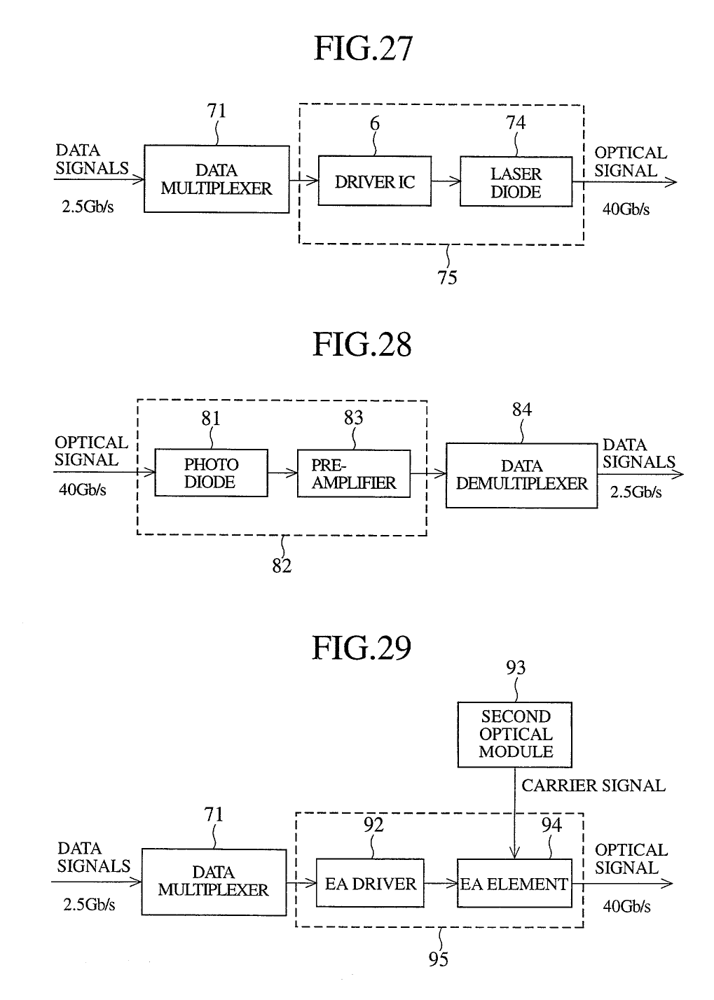

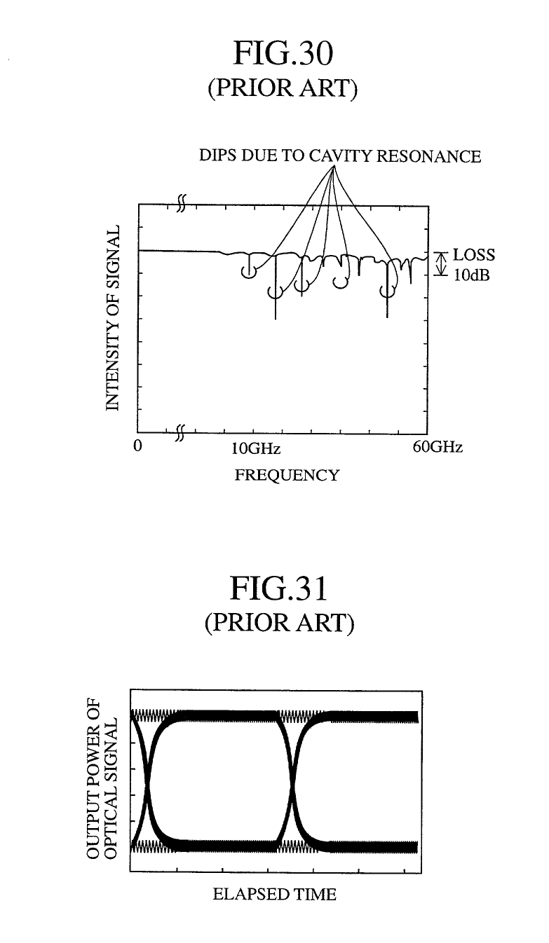

FIG. 27 is a block diagram of an optical transmitter according to an eleventh embodiment of the present invention, and FIG. 28 is a block diagram of an optical receiver according to the eleventh embodiment.

An optical transmitter having an optical module will be initially described with reference to FIG. 27. The optical module of the optical transmitter has a package structure described according to one of the first to tenth embodiments, and a laser diode is arranged in the optical module as the optical semiconductor element 4.

In FIG. 27, 71 indicates a data multiplexer for multiplexing a plurality of electric signals (for example, 16 electric signals) respectively having a data transfer rate of 2.5 Gb/s (2.5×10⁹ bits/s) to produce a multiplexed electric signal of 40 Gb/s. The multiplexed electric signal obtained in the data multiplexer 71 is amplified in the driver IC 6 to produce a modulating signal (or a high frequency signal). 74 indicates a laser diode. The laser diode 74 is actuated by the modulating signal, and an optical signal of 40 Gb/s is output from the laser diode 74 in response to the modulating signal. 75 indicates an optical module described according to one of the first to tenth embodiments. The driver IC 6 and the laser diode 74 are arranged in the optical module 75. An interface unit for the laser diode 74 is composed of the driver IC 6 and the data multiplexer 71. Also, the driver IC 6 is arranged in the optical module 75 in the example shown in FIG. 27. However, it is applicable that the driver IC 6 be arranged on the outside of the optical module 75.

In the above configuration, the high frequency signal is produced in the driver IC 6 according to the multiplexed electric signal produced in the data multiplexer 71, the laser diode 74 is actuated according to the high frequency signal, and the optical signal of 40 Gb/s is output from the laser diode 74. The optical signal output from the laser diode 74 is sent to an external device (for example, an optical receiver) through the optical fiber 15 attached to the optical module 75.

Next, an optical receiver having an optical module will be described with reference to FIG. 28. The optical module of the optical receiver has a package structure described according to one of the first to tenth embodiments, and a photo diode is arranged in the optical module as the optical semiconductor element 4.

In FIG. 28, 81 indicates a photo diode for converting an optical signal of 40 Gb/s into an electric signal. 82 indicates an optical module for receiving the optical signal sent from an optical transmitter through the optical fiber 15 and outputting the electric signal obtained in the photo diode 81. 83 indicates a pre-amplifier for amplifying the electric signal including a high frequency signal output from the photo diode 81. 84 indicates a data demultiplexer for demultiplexing the electric signal amplified in the pre-amplifier 83 to produce a plurality of electric signals (for example, 16 electric signals) respectively having a data transfer rate of 2.5 Gb/s. An interface unit for the photo diode 81 is composed of the pre-amplifier 83 and the data demultiplexer 84. Also, in the example shown in FIG. 28, the pre-amplifier 83 is arranged in the optical module 82. However, it is applicable that the pre-amplifier 83 be arranged on the outside of the optical module 82.

In the above configuration, the optical signal sent from an optical transmitter through the optical fiber 15 is transformed into the electric signal in the optical module 82 with the photo diode 81, and the electric signal is demultiplexed to a plurality of electric signals. The electric signals are sent as data signals to an external device through a signal line (not shown).

In this embodiment, an optical transceiver of 40 Gb/s can be, for example, obtained by arranging the optical transmitter shown in FIG. 27 and the optical receiver shown in FIG. 28 in a box.

As is described above, an optical transmitter, an optical receiver and an optical transceiver can be obtained by using the optical module described according to one of the first to tenth embodiments.

Embodiment 12

FIG. 29 is a block diagram of an optical transmitter according to a twelfth embodiment of the present invention.

In FIG. 29, 71 indicates the data multiplexer for multiplexing a plurality of data signals (for example, 16 data signals) respectively having a data transfer rate of 2.5 Gb/s to produce a multiplexed data signal of 40 Gb/s. 95 indicates a first optical module having a package structure described according to one of the first to tenth embodiments. In the first optical module 95, an electroabsorption (EA) element 94 is used as the optical semiconductor element 4. 92 indicates an EA driver for actuating the EA element 94. The multiplexed data signal obtained in the data multiplexer 71 is amplified in the EAdriver 92 to produce a modulating signal. The modulating signal includes a high frequency signal. An interface unit for the EA element 94 is composed of the data multiplexer 71 and the EA driver 92.

93 indicates a second optical module having a package structure, for example, described according to the first embodiment. In the second optical module 93, the laser diode 74 is used as the optical semiconductor element 4, and an optical signal having a constant intensity is output as a carrier signal according to an input signal of a constant bias current. Because no high frequency signal is used in the second optical module 93, it is not required of the second optical module 93 to have the package cover 2 with the electromagnetic wave absorptive element 19.

In the EA element 94 of the first optical module 95, the carrier signal output from the second optical module 93 is modulated according to the modulating signal including the high frequency signal output from the EA driver 92 to obtain an optical signal of 40 Gb/s, and the optical signal is output.

As is described above, in the twelfth embodiment, a plurality of data signals (for example, 16 data signals) of 2.5 Gb/s are transformed into an optical signal of 40 Gb/s by using the first optical module 95 with the EA element 94 and the second optical module 93 with the laser diode 74, and the optical signal is sent to an optical receiver through the optical fiber 15. Accordingly, an optical transmitter can be obtained by using the first optical module 95 and the second optical module 93.

Also, an optical transceiver of 40 Gb/s can be, for example, obtained by arranging the optical transmitter shown in FIG. 29 and the optical receiver shown in FIG. 28 in a box.

In the twelfth embodiment, the EA driver 92 is arranged in the first optical module 95. However, it is applicable that the EA driver 92 be arranged on the outside of the first optical module 95.

Also, in the eleventh and twelfth embodiments, the optical transmitter and the optical receiver are separately described. However, it is apparent that the optical transmitter and the optical receiver can be combined. Therefore, the present invention can be applied to an optical transceiver having an optical transmitting function and an optical receiving function in addition to the optical transmitter and the optical receiver.

What is claimed is:

1. An optical module, comprising:
an optical semiconductor element for receiving or outputting a high frequency signal;
a package having a cavity in which the optical semiconductor element is placed;
an electromagnetic wave absorptive element, arranged on an inner surface of the package, for attenuating electromagnetic waves which are generated in the cavity of the package by the high frequency signal; and
a seal element for covering the electromagnetic wave absorptive element and hermetically sealing the electromagnetic wave absorptive element from the cavity of the package, the seal element being made of material which allows the electromagnetic waves to penetrate therethrough.

2. An optical module according to claim 1, wherein the package has a package box and a package cover which are joined to each other, and wherein the package cover is formed with the inner surface on which the electromagnetic wave absorptive element is arranged.

3. An optical module according to claim 2, wherein the package cover includes a metal layer or a metal substrate.

4. An optical module according to claim 2, wherein the package has a concavity in which the electromagnetic wave absorptive element is arranged, and wherein the concavity is covered with the seal element to hermetically seal the electromagnetic wave absorptive element from the cavity of the package.

5. An optical module according to claim 2, wherein the package cover has a dielectric substrate, a metal layer covering an outer surface of the dielectric substrate, and a metal ring surrounding the dielectric substrate and joined to the package box.

6. An optical module according to claim 1, wherein the package has a package box, which has a bottom wall portion and a side wall portion, and a package cover which is joined to the side wall portion of the package box, and wherein the side wall portion of the package box is formed with the inner surface on which the electromagnetic wave absorptive element is arranged.

7. An optical module according to claim 1, wherein the package has a package box, which has a bottom wall portion and a side wall portion, and a package cover which is joined to the side wall portion of the package box, and wherein the bottom wall portion of the package box is formed with the inner surface on which the electromagnetic wave absorptive element is arranged.

8. An optical module according to claim 1, wherein the seal element is formed of a coating layer with which all surfaces of the electromagnetic wave absorptive element are covered, and a combination of the electromagnetic wave absorptive element and the coating layer is attached to the inner surface of the package.

9. An optical module according to claim 8, wherein the coating layer is formed of a dielectric material.

10. An optical module according to claim 1, wherein the electromagnetic wave absorptive element includes a conductive or magnetic material and an organic material.

11. An optical module according to claim 1, wherein the package has a wall portion which is made of metal, and wherein the wall portion is formed with the inner surface on which the electromagnetic wave absorptive element is arranged.

12. An optical module according to claim 1, wherein the package has a wall portion of which an outer surface is covered with a metal layer, and wherein the wall portion is formed with the inner surface on which the electromagnetic wave absorptive element is arranged.

13. An optical module according to claim 1, wherein the seal element is made of dielectric material.

14. An optical module according to claim 1, wherein the optical semiconductor element is formed of a laser diode.

15. An optical module according to claim 1, wherein the optical semiconductor element is formed of an electroabsorption element.

16. An optical module according to claim 1, wherein the optical semiconductor element is formed of a photo diode.

17. An optical module, comprising:
an optical semiconductor element for receiving or outputting a high frequency signal;
a package having a cavity, in which the optical semiconductor element is placed, and a wall portion which allows electromagnetic waves to penetrate therethrough;
an electromagnetic wave absorptive element, arranged on an outer surface of the wall portion of the package, for attenuating electromagnetic waves which are generated in the cavity of the package by the high frequency signal; and
a metal layer for covering an outer surface of the electromagnetic wave absorptive element.

18. An optical module according to claim 17, wherein the electromagnetic wave absorptive element includes a conductive or magnetic material and an organic material.

19. An optical module according to claim 17, wherein the optical semiconductor element is formed of a laser diode.

20. An optical module according to claim 17, wherein the optical semiconductor element is formed of an electroabsorption element.

21. An optical module according to claim 17, wherein the optical semiconductor element is formed of a photo diode.

22. An optical module according to claim 17, wherein the package has a package box and a package cover which are joined to each other, the package cover has a dielectric substrate equivalent to the wall portion and a metal ring which surrounds the dielectric substrate and is joined to the package box.

23. An optical module, comprising:
an optical semiconductor element for receiving or outputting a high frequency signal;
a circuit electrically connected to the optical semiconductor element;
a first package having a cavity in which the optical semiconductor element is placed;
a second package having a cavity in which the circuit and the first package are placed;
an electromagnetic wave absorptive element, arranged on an inner surface of the second package, for attenuating electromagnetic waves which are generated in the cavity of the second package by the high frequency signal; and
a seal element for covering the electromagnetic wave absorptive element and hermetically sealing the electromagnetic wave absorptive element from the cavity of the second package, the seal element being made of material which allows the high frequency signal to penetrate therethrough.

24. An optical module according to claim 23, further comprising a constant temperature element, which is placed in the cavity of the second package and has the first package placed thereon, for keeping a temperature of the optical semiconductor element at a constant value through the first package.

25. An optical module, comprising:
an optical semiconductor element for receiving or outputting a high frequency signal;
a circuit electrically connected to the optical semiconductor element;
a first package having a cavity in which the optical semiconductor element is placed; and
a second package having a cavity in which the circuit and the first package are placed.

26. An optical module according to claim 25, wherein the second package has a package box and a package cover which are joined to each other, and wherein the package cover of the second package has a protrusive portion which faces the circuit.

27. An optical module according to claim 26, further comprising a constant temperature element, which is placed in the cavity of the second package and has the first package placed thereon, for keeping a temperature of the optical semiconductor element at a constant value through the first package.

28. An optical transmitter, comprising:
an interface unit for receiving electric signals and outputting a high frequency signal; and
an optical module for receiving the high frequency signal from the interface unit and outputting an optical signal, wherein the optical module comprises:
an optical semiconductor element for receiving the high frequency signal and producing the optical signal;
a package having a cavity in which the optical element is placed;
an electromagnetic wave absorptive element, arranged on an inner surface of the package, for attenuating electromagnetic waves which are generated in the cavity of the package by the high frequency signal; and
a seal element for covering the electromagnetic wave absorptive element and hermetically sealing the electromagnetic wave absorptive element from the cavity of the package, the seal element being made of material which allows the high frequency signal to penetrate therethrough.

29. An optical transmitter according to claim 28, wherein the interface unit comprises a multiplexer for multiplexing the electric signals to produce the high frequency signal.

30. An optical transmitter according to claim 29, wherein the optical semiconductor element of the optical module is formed of a laser diode, and the interface unit further comprises a driver circuit for amplifying the high frequency signal produced by the multiplexer to output an amplified high frequency signal to the laser diode.

31. An optical transmitter according to claim 29, further comprising a second optical module for receiving an electric signal and outputting a second signal, wherein the optical module is a first optical module having the optical semiconductor element formed of an electroabsorption element, and wherein the first optical module comprises a driver circuit for amplifying the high frequency signal produced by the multiplexer and outputting an amplified high frequency signal to the electroabsorption element to make the electroabsorption element convert the second optical signal output from the second optical module into the optical signal according to the amplified high frequency signal and output the optical signal.

32. An optical transmitter according to claim 31, wherein the driver circuit is placed in the cavity of the package.

33. An optical receiver, comprising:
an optical module for receiving an optical signal and outputting a high frequency signal; and
an interface unit for receiving the high frequency signal from the optical module and outputting electric signals, wherein the optical module comprises:
a photo diode for receiving the optical signal and producing the high frequency signal;
a package having a cavity in which the photo diode is placed;
an electromagnetic wave absorptive element, placed on an inner surface of the package, for attenuating electromagnetic waves which are generated in the cavity of the package by the high frequency signal; and
a seal element for covering the electromagnetic wave absorptive element and hermetically sealing the electromagnetic wave absorptive element from the cavity of the package, the seal element being made of material which allows the high frequency signal to penetrate therethrough.

34. An optical receiver according to claim 33, wherein the interface unit comprises a demultiplexer for demultiplexing the high frequency signal produced by the photo diode to produce electric signals.

35. An optical receiver according to claim 34, wherein the interface unit further comprises an amplifier for amplifying the high frequency signal and outputting an amplified high frequency signal to the demultiplexer to make the demultiplexer produce the electric signals from the amplified high frequency signal.
